(19) United States
(12) Patent Application Publication
(10) Pub. No.: US 2010/0233919 A1
(43) Pub. Date: Sep. 16, 2010

(54) Check valve turbine

(76) Inventor: Seyhan Ersoy, Bethlehem, PA (US)

Correspondence Address: ARENT FOX LLP, 1050 CONNECTICUT AVENUE, N.W., SUITE 400, WASHINGTON, DC, 20036, US

(21) Appl. No.: 12/382,305

(22) Filed: Mar. 12, 2009

(51) Int. Cl. B63H 13/00; G01C 21/00; F03D 3/06; F03D 9/00

(52) U.S. Cl. 440/8; 701/213; 416/119; 290/55

(57) ABSTRACT

Aspects of an embodiment of a check valve turbine assembly include a rotation platform having an axis of rotation, a vertical member concentrically secured to the rotation platform about the axis of rotation, a rotatable sail assembly attached to the vertical member that includes a frame, a hinge beam, and a rotatable sub-sail assembly. The sub-sail assembly includes a stem beam, a sub-sail grid frame attached to the stem beam, and a plurality of flaps rotatably attached to the sub-sail grid frame and configured to move between a closed position and an open position relative to the sub frame. Aspects of a marine check valve turbine include a free-floating platform structure configured with an upper surface at or near a water surface and a vertical member secured to the platform structure about an axis of rotation and configured to extend from the upper surface of the platform structure.

### CROSS-REFERENCE TO RELATED APPLICATION

This application is related to U.S. Non-Provisional patent application Ser. No. 12/331,947, titled CHECK VALVE TURBINE, filed Dec. 12, 2008, the entirety of which is hereby incorporated by reference herein.

### BACKGROUND OF THE INVENTION

Rising fuel prices and increased awareness of global warming has placed increased emphasis on the use of renewable resources to produce energy to answer the ever increasing demand for energy. One of the earliest energy sources used by humans was wind to power sail boats and windmills. However, cheap fossil fuels rendered sail boats obsolete for commercial applications. These days sail boats are used primarily for leisure purposes only.

Ancient Greeks and Romans carried cargo on the Mediterranean Sea more than 2000 years ago by using the power of the wind. It is ironic that one of the first renewable uses of the wind is the least used commercially today. There are megawatt wind turbines to power thousands of homes, but a suitable wind turbine does not exist to power a boat, for example.

In particular, when wind speed and direction are not predictable, the use of current wind turbines becomes unreliable for commercial use, such as for powering sail boats. For example, wind does not always blow from behind the boat (i.e., from the stern direction), making the sail system of the boat complex, which can require a large crew for maintenance. Also, when the wind is coming from the bow (front) direction of the boat, the boat under sail must tack (zigzag in course to advance forward), which consumes precious time, energy, resources, and the like. At the same time, when the boat reaches a destination, during loading and unloading, there is no power being generated by the sails which can be stored and used later to propel or power the boat or, at least, aspects of the boat.

Conventional three bladed wind turbines are not suitable for marine applications due to their heavy power generation components which are located at the so-called nacelle, high above the sea level. A high center of gravity and moment of a wind force acting on the blades would render a sail boat powered by a conventional three bladed turbine very unstable. Also, a constant change in wind and boat direction requires that the blades of the three bladed turbine are always adjusted toward the wind, which consumes a lot of precious energy that could otherwise be used to propel the boat. Another significant disadvantage of the three bladed turbine is that the blades do not function in the manner of a sail even when the wind is blowing from the stern (behind) of the boat. As such, any power from the wind must always be converted to electricity to power the boat through use of the turbine. For example, assuming that a conventional wind turbine with a high efficiency of 59.3% was employed, as predicted by the Betz limit, 40% of the wind power is still lost when the wind is coming from the stern (behind) side of the boat. As such, a turbine system that can also be employed as a conventional sail allows for increased efficiency by capturing the full energy of the wind when the direction of the wind is coming from a suitable direction.

For centuries, wind power has been a source of energy and has been harnessed in various fashions. There is a clear distinction between the manners in which the wind energy is harnessed. In particular, there are horizontal axis wind turbines (HAWTs) and vertical axis wind turbines (VAWTs).

In modern times, the prevalent methodology for harnessing the wind energy has been to use a HAWT, which typically uses three airfoil sails. While HAWT's have been promoted as being the more efficient relative to VAWTs, HAWTs present several disadvantages. For example, HAWT's are mono-directional, which means they have to be turned into the wind. Also, the minimum operational wind speed (cut-in speed) of HAWTs is relatively high and the maximum wind speed (cut-out speed) that can be endured is relatively low, allowing for only a relatively narrow window of operation, beyond which they are prone to damage and have to stop operating. Furthermore, the serviceable components of HAWTs usually sit high up in the so-called nacelle, on top of a tall pillar, which is rather inconvenient for servicing and replacement of parts. Moreover, although HAWTs are considered “fast-runners” based on their lift factor, the actual slewing speed of HAWTs is relatively low (typically in the range of 15 to 30 RPM), which necessitates expensive multi-stage gearboxes and negatively impacts the overall system efficiency and costs. Further, the overall design of HAWTs does not facilitate or make practical “do-it-yourself construction.”

Currently, the commercial application of wind energy harnessing techniques is primarily, if not, exclusively, HAWT focused even though VAWTs avoid most of the above disadvantages inherent in HAWTs. For example, and by no means limiting, VAWTs are omni-directional and have a lower cut-in wind speed and higher cutout speed, thus making the window of operation wider. Also, VAWTs have serviceable components that can be concentrated or located at a bottom end of the structure, thereby providing easy accessibility and increased efficiencies. For example, HAWTs are configured with the power producing components located in a nacelle that is exposed to the wind. As such, the nacelle is designed to be as small as possible to reduce wind drag. The size restriction of the nacelle requires that a diameter of the generator used in an HAWT must be reduced, requiring an expensive gearbox configuration. VAWTs, on the other hand, may be configured with the power producing components at a base portion of the structure, or below ground or sea level, for example, where the power producing components are not exposed to the wind. The VAWT configuration allows for a larger diameter generator, for example, without even the necessity of a gearbox. Moreover, VAWTs are considered “low runners” as a result of their low lift factor, and because VAWTs actually slew faster compared to HAWTs, VAWTs allow for smaller-ratio gearboxes, which are less expensive and more efficient than the gearboxes needed to operate HAWTs. VAWTs also are able to operate at higher wind speeds and at a lower risk of suffering wind damage. For at least all of the reasons described above, VAWTs are capable of a more simple design and construction over other conventional wind turbine designs.

Two main types of VAWTs are described below, a lift based (pull) type and drag based (push) type.

### Lift Based (Pull) Type VAWTs

One of the more popular lift based or pull type VAWTs is the Darrieus Wind Turbine (see FIG. 1), which is characterized by C-shaped rotor sails, which appear similar to modern day eggbeaters. The Darrieus Wind Turbine normally includes two or three sails and was patented in 1931 by a French aeronautical engineer named Georges Jean Marie Darrieus.

In the original versions of the Darrieus design, the aerofoils were arranged symmetrically with no (i.e., zero) rigging angles. That is, the aerofoils are set at an angle relative to the structure on which they are mounted. This arrangement is equally effective regardless of the direction the wind is blowing, which is in contrast to the conventional arrangement needed to face the wind to rotate.

As shown in FIGS. 2A and 2B, when the Darrieus rotor is spinning, the aerofoils move forward through the air in a circular path. Relative to the sail, the oncoming airflow is added vectorially to the wind, so that the resultant airflow creates a varying small positive angle of attack (AoA) to the sail and generates a net force pointing obliquely in a forward direction along a “line-of-action.” The net force is projected inwards past the turbine axis at a given distance, providing a positive torque to the shaft, thereby helping the shaft rotate in the direction it is already traveling. The aerodynamics rotating the rotor is equivalent to autogiros and normal helicopters in autorotation.

As the aerofoil moves around the back of the apparatus, the angle of attack changes to the opposite sign, but the generated force is still oblique relative to the direction of rotation because the wings are symmetrical and the rigging angle is still zero. Accordingly, the rotor spins at a rate unrelated to the wind speed and usually many times faster than the wind speed. The energy arising from the torque and speed may be extracted and converted into useful power by using an electrical generator.

The aeronautical terms lift and drag are, strictly speaking, forces across and along the approaching sail relative to the airflow, so they are not useful here. What is important to determine is the tangential force pulling the sail around and the radial force acting against the bearings of the assembly.

When the rotor is stationary, no net rotational force arises, even if the wind speed increases relatively high as the rotor is already spinning to generate torque. Thus, the design is normally not self-starting. It should be noted though, that under extremely rare conditions, Darrieus rotors can self-start, so some form of braking is required to hold the rotor when stopped.

One problem with the design is that the angle of attack changes as the turbine spins, so each sail generates its maximum torque at two points on its cycle (front and back of the turbine). This leads to a sinusoidal (pulsing) power cycle that complicates the overall design. In particular, almost all Darrieus turbines have resonant modes where, at a particular rotational speed, the pulsing power cycle coincides with a natural frequency of the sails that can cause the sails to break. For this reason, most Darrieus turbines have mechanical brakes or other speed control devices to keep the turbine from spinning at such speeds for a lengthy period of time.

Another problem with the design arises due to the mass of the rotating mechanisms being at the periphery rather than at the hub, as with a propeller. The design creates very high centrifugal stress levels on the mechanism, which must be stronger and heavier than otherwise would be needed just to, withstand the force. One common approach to minimize the force is to curve the wings into an “egg-beater” shape (this is called a “troposkein” shape, derived from the Greek for “the shape of a spun rope”) such that they become self supporting and do not require such heavy supports and mountings.

In this configuration, the Darrieus design is theoretically less expensive than a conventional design as most of the stress is in the sails which torque against the generator located at the bottom of the turbine. The only forces that need to be vertically balanced are the compression load that is created by the sails flexing outward (thus attempting to “squeeze” the tower), and the wind force, which may knock the turbine over, half of which is transmitted to the bottom of the turbine and the other half of which is easily offset by using guy wires.

By contrast, a conventional design has the entire wind force attempting to push the tower over at the top, which is where the main bearing is located. Additionally, guy wires are not easily used to offset the load because the propeller spins both above and below the top of the tower. Thus, the conventional design requires a strong tower that grows exponentially with the size of the propeller. Modern designs can compensate most tower loads of that variable speed and variable pitch.

Overall, while there are some advantages in the aforementioned Darrieus design, there are many more disadvantages, especially with bigger machines in the MW class. Also, the Darrieus design uses more expensive materials for the sails while most of the sail is too close to the ground to provide enough power. Traditional designs assume that wing tip is at least 40 m from ground at the lowest point to maximize energy production and life time. So far, there is no known material (including carbon fiber) which can meet cyclic load requirements of the Darrieus design.

While in theory the Darrieus design is as efficient as the propeller type design if the wind speed is constant, in practice such efficiency is rarely realized due to the physical stresses and limitations imposed by the practical design and wind speed variations. There are also substantial difficulties in protecting the Darrieus turbine from extreme wind conditions and in making it a self-starting assembly.

Darrieus' 1927 patent also disclosed several embodiments that used vertically arranged airfoils. See FIG. 3. One of the more common vertical airfoils is the Giromill or H-bar design shown in FIG. 4 wherein the long “egg beater” sails of the common Darrieus design are replaced with straight vertical sail sections attached to the central tower via horizontal supports. The Giromill sail design is much simpler to build, but puts more weight into the structure as opposed to sails, which means that the sails themselves have to be stronger.

Another variation of the Giromill is the Cycloturbine, which has sails that are mounted such that the sails can rotate around their vertical axis. The design of the Cyclotrubine allows the sails to be “pitched” such that the sails are always at an angle relative to the wind. The main advantage to this design is the torque generated remains almost constant over a fairly wide angle. Therefore, a Cycloturbine with three or four sails has a fairly constant torque. Over a predetermined range of angles, the torque approaches the possible maximum torque, wherein the system generates more power. The Cycloturbine also has the advantage of being able to self start by pitching the “downwind moving” sail flat to the wind to generate drag and start the turbine spinning at a low speed. One drawback to this design is that the sail pitching mechanism is complex and generally heavy, and a wind-direction sensor must be added to the design in order to properly pitch the sails.

The sails of the Darrieus turbine can be canted into a helix, e.g. three sails and a helical twist of 60 degrees, similar to Gorlov's water turbines, as shown in FIG. 5. Since the wind pulls each sail around on both the windward and leeward sides of the turbine, this feature spreads the torque evenly over the entire revolution, thus preventing destructive pulsations. Moreover, the skewed leading edges reduce resistance to rotation by providing a second turbine above the first, and having oppositely directed helices, the axial wind-forces cancel, thereby minimizing wear on the shaft bearings. Another advantage of the helical design is that the sails generate good torque from upward-slanting airflows, which typically occurs above roofs and cliffs. The helical design is used by the Turby and Quiet Revolution brand of wind turbines.

Drag Based (Push) type VAWTs

The Savonius wind turbine, which is shown in FIG. 6, was invented by a Finnish engineer named S. J. Savonius. The Savonius design is an example of the drag based (push type) VAWT. The Savonius turbine can be made with different types of scoops (e.g. buckets, paddles, sail or oil drums.). For example, if one were to view the rotor of a two scoop machine from a bird's eye view, the scoops would create a cross section that would appear to have and “S” shape. While rather low in efficiency but high in torque, the Savonius turbine is used mainly for weed grinding and water pumping applications.

FIG. 7 illustrates a direction adjusting sail type design of a drag based wind turbine. The turbine in this design uses a sail like structure for sails, wherein when the sail is moving in the downwind direction, each sail exposes the entire surface of the sail to the wind. However, when moving in the upwind direction, each sail shows a minimum surface area to the wind. The structure of this design requires a complex adjusting mechanism, wherein the reaction time to any such adjustment is rather slow due to the size of the sails. The sails of this design, which are rather large, are also prone to damage because of their latency to react to the changing wind directions.

A big flap design, which is shown in FIG. 8, is another drag based wind turbine and has a rather simple mechanism that is used to open and close flaps. However, the flap size of the big flap design limits the operation of the turbines and the design does not lend itself to large turbines.

The VAWTS having the highest efficiency that have been described are the Darrieus and Giromills designs. Maintenance issues and sail fatigue which cause premature failure of a system are common problems associated with the Darrieus wind turbine design.

Drag type VAWTs have a substantially low efficiency, which is determined by the ratio between the latent wind energy and the actual power output. One of the main reasons for the inefficiency is half of the sail is moving in the wrong direction, that is, towards the oncoming wind, at any given time. The relative wind speed on the sail moving towards the oncoming wind is higher than the wind speed on the downwind moving sail, wherein the high velocity creates higher drag on the sail moving towards the oncoming wind.

### SUMMARY OF INVENTION

A marine check-valve turbine, i.e., a VAWT-type turbine, as disclosed herein, may be used with boats and other marine systems, as well as other wind powered vehicles or systems, to solve the problems associated with current technology. First, any heavy power producing components of the check-valve turbine may be positioned below or close to sea or ground level, which may lower a center of gravity of the system. The marine check-valve turbine disclosed herein is omni directional, and as such, is not affected by a change in a direction of the wind or a heading direction of the boat. A sail of the inventive marine check-valve turbine may be used as a regular sail to propel the boat, i.e., to push the boat when the wind direction is blowing from behind (stern direction) the turbine, without the need to strictly generate electricity, thereby saving significant amounts of precious energy needed to propel the boat. Moreover, the inventive marine check-valve turbine generates and stores power for future use even if the boat is not traveling, e.g., moored, in harbor, loading or unloading its cargo. The inventive marine check-valve turbine provides a preferable manner of generating and/or storing power for boats or other marine vessels, is inexpensive to manufacture and is lightweight compared to conventional technologies.

The marine check-valve turbine may be used to generate electricity or hydrogen to power a boat or a ship, or for use on hydrogen production platforms, for example, in open seas. A boat, for example, may use large hydraulic accumulators to store the wind energy for propelling the boat at a later time. Although disclosed as a marine check-valve turbine, the marine check-valve turbine may be used for land applications, with minor modifications, as would occur to a person of ordinary skill in the art. Furthermore, although disclosed for use on a boat, the check-valve turbine may be used on any vessel for power or propulsion, whether on land, sea, or in the air.

Although reference herein may be made to use on a boat or marine vessel, the current invention is not limited to such use. For example, the check valve turbine of the present invention may be used to produce power on a variety of platforms or vehicles, any of which may be suitable for land, sea or air applications.

### BRIEF DESCRIPTION OF THE DRAWINGS

Various aspects of the present invention are illustrated by way of example, and not by way of limitation, in the accompanying drawings, wherein:

FIG. 1 is a perspective view of a conventional Darrieus-type wind turbine;

FIGS. 2A and 2B are schematic diagrams of a conventional Darrieus-type wind turbine in operation;

FIG. 3 is a perspective view of another conventional Darrieus-type wind turbine with vertically arranged airfoils;

FIG. 4 is a perspective view of a conventional Giromill or H-bar vertical airfoil;

FIG. 5 is a perspective view of another conventional Darrieus turbine with sails canted into a helix;

FIG. 6 is a schematic diagram of a conventional Savonius wind turbine;

FIG. 7 is a diagram of a conventional direction adjusting sail type design of a drag based wind turbine;

FIG. 8 is a diagram of a conventional big flap type design of a drag based wind turbine;

FIG. 9 shows a Vertical Axis Wind Turbine (VAWT) in accordance with aspects of the present invention;

FIGS. 10A, 10B and 10C show a front view, a side view and a top view of the vertical frame members of the VAWT in accordance with aspects of the present invention;

FIGS. 11A, 11B and 11C show a top view, a front view and a side view of an of the horizontal frame members of the VAWT in accordance with aspects of the present invention;

FIG. 12 shows a top perspective view of the sails and operational aspects of the VAWT in accordance with aspects of the present invention;

FIGS. 13A and 13B show a top view of a sails with flaps in a closed position and in an open position, respectively, in accordance with aspects of the present invention;

FIGS. 14A and 14B show reverse sides of a flap in an open position and FIG. 14C shows a side view of the same flap, in accordance with aspects of the present invention;

FIG. 15 shows the flaps as provided in extruded grooves in accordance with aspects of the present invention;

FIG. 16 shows a VAWT with rigid sails having a scoop-like structure in accordance with aspects of the present invention;

FIGS. 17A and 17B show the front and back of a membrane flap in accordance with aspects of the present invention;

FIGS. 17C and 17D show the front and back of a rigid scoop flap in accordance with aspects of the present invention;

FIG. 18 shows a VAWT with sub-sail assemblies in accordance with aspects of the present invention;

FIG. 19 is a schematic diagram showing a top view of a sail with sub-sails attached in accordance with aspects of the present invention;

FIG. 20 shows a VAWT with rotating sub-sails in accordance with aspects of the present invention;

FIG. 21 illustrates a VAWT with a rigid grid having holes in accordance with aspects of the present invention;

FIG. 22 is a top view of a flexible flap attached to a rigid base in accordance with aspects of the present invention;

FIG. 23 is a top view of a VAWT with rigid sails having flexible flaps in accordance with aspects of the present invention;

FIG. 24 shows a VAWT system used on a sail boat in accordance with aspects of the present invention;

FIG. 25 shows a VAWT system where flaps act as a check-valve in accordance with aspects of the present invention;

FIG. 26 shows a close up of the flap shown in FIG. 25 in accordance with aspects of the present invention;

FIG. 27 shows an elastic flap assembly in accordance with aspects of the present invention;

FIG. 28 shows an elastic flap assembly wherein the aluminum profile includes extensions in accordance with aspects of the present invention;

FIG. 29 shows a relief mechanism for a flap in accordance with aspects of the present invention;

FIGS. 30A and 30B are schematic diagrams showing another relief mechanism in accordance with aspects of the present invention;

FIGS. 31A and 31B are schematic diagrams showing yet another exemplary relief mechanism in accordance with aspects of the present invention;

FIG. 32 shows yet another exemplary relief mechanism in accordance with aspects of the present invention;

FIG. 33 shows a VAWT for use on a marine vessel for generating electricity in accordance with aspects of the present invention;

FIG. 34 shows the same marine vessel with the sub-sails of the VAWT in a closed position to the direction of the wind in accordance with aspects of the present invention;

FIG. 35 shows the same marine vessel with the sails of the VAWT in a folded position in accordance with aspects of the present invention;

FIG. 36 shows the same marine vessel with the sails positioned to catch the wind blowing from the direction of the stern of the vessel, in accordance with aspects of the present invention;

FIG. 37 illustrates a rack and pinion control system for use with a VAWT, in accordance with aspects of the present invention;

FIG. 38 shows the sub-sails of a VAWT folded toward a positive face by the rack and pinion control system in accordance with aspects of the present invention;

FIG. 39 shows the same sub-sails of a VAWT folded toward a negative face by the rack and pinion control system in accordance with aspects of the present invention;

FIG. 40 shows a pneumatic type rack and pinion control system for use on a VAWT in accordance with aspects of the present invention;

FIG. 41 illustrates a two-leafed flap mechanism for use on a VAWT in accordance with aspects of the present invention;

FIG. 42 shows the same two-leafed flap mechanism in a positive motion with the wind in accordance with aspects of the present invention;

FIG. 43 illustrates another embodiment of a two-leafed flap mechanism for use on a VAWT in accordance with aspects of the present invention;

FIG. 44 shows a rear view of the same two-leafed flap mechanism in a positive motion with the wind in accordance with aspects of the present invention;

FIG. 45 shows a marine application of a check-valve VAWT in accordance with aspects of the present invention;

FIG. 46 illustrates a check-valve VAWT mounted on a power platform in accordance with aspects of the present invention;

FIG. 47 illustrates a typical hydraulic or pneumatic motor that may be used to rotate the sails and sub-sails of a VAWT in accordance with aspects of the present invention;

FIG. 48 shows a mechanical diagram of aspects of a sub-sail for use on a check-valve turbine in accordance with aspects of the present invention;

FIG. 49 shows an exemplary embodiment of a sub-sail stem beam 2010 from a positive face perspective of the sub-sail in accordance with aspects of the present invention;

FIG. 50 shows the same stem beam 2010 from a negative face perspective of the sub-sail in accordance with aspects of the present invention;

FIG. 51 shows one sail with three sub-sails in three different working modes of a three-sail VAWT in accordance with aspects of the present invention;

FIG. 52 illustrates a cage supported by support arms for use with a VAWT in accordance with aspects of the present invention;

FIG. 53 shows a sub-sail with a trimmed portion to avoid interference with a support ring on a cage for use with a VAWT in accordance with aspects of the present invention;

FIG. 54 shows fixed flow directing sails attached at an outer part of a cage structure for a VAWT in accordance with aspects of the present invention;

FIG. 55 shows a ring gear to roller gear power transmission mechanism for use with a VAWT in accordance with aspects of the present invention;

FIG. 56 shows a ring gear to sun gear power transmission system that includes a planetary gear mechanism for use with a VAWT in accordance with aspects of the present invention;

FIG. 57 shows a ring gear to sun gear power transmission system that includes two smaller planetary gear mechanisms for use with a VAWT in accordance with aspects of the present invention;

FIG. 58 illustrates an exemplary embodiment of a support bearing system for use on a VAWT in accordance with aspects of the present invention;

FIG. 59 shows the support bearing system fully assembled for use on a VAWT in accordance with aspects of the present invention;

FIG. 60 shows an exemplary embodiment of another support roller system for use with a VAWT in accordance with aspects of the present invention;

FIG. 61 illustrates the power generation components of a conventional three bladed HWAT nacelle;

FIG. 62 shows a hydraulic accumulator system for use with a marine check-valve turbine in accordance with aspects of the present invention;

FIG. 63 shows another embodiment of the hydraulic accumulator system in which the system is a closed system and includes a reservoir tank in accordance with aspects of the present invention; and

FIGS. 64A and 64B show a flap mounting system in accordance with aspects of the present invention.

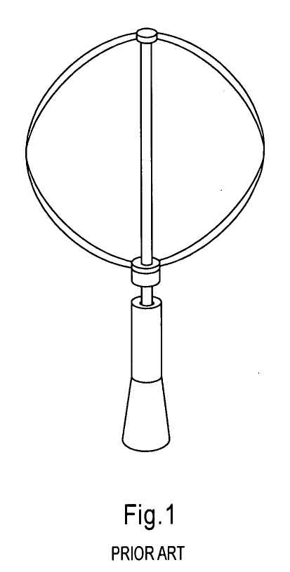

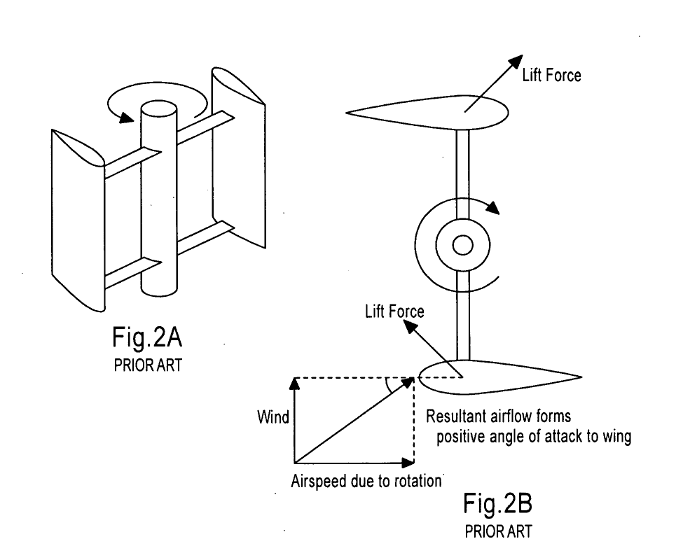

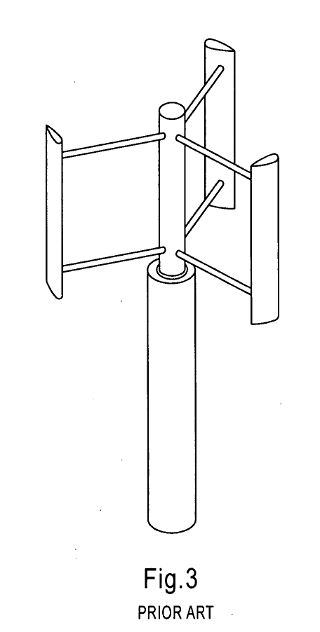

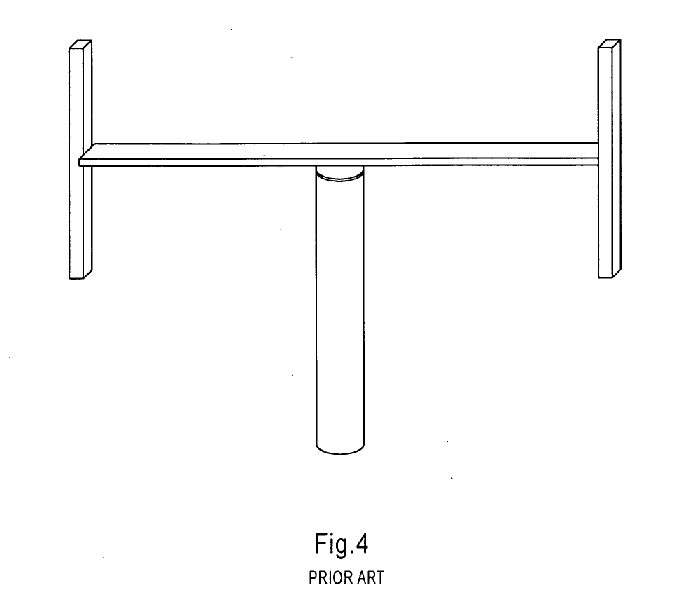

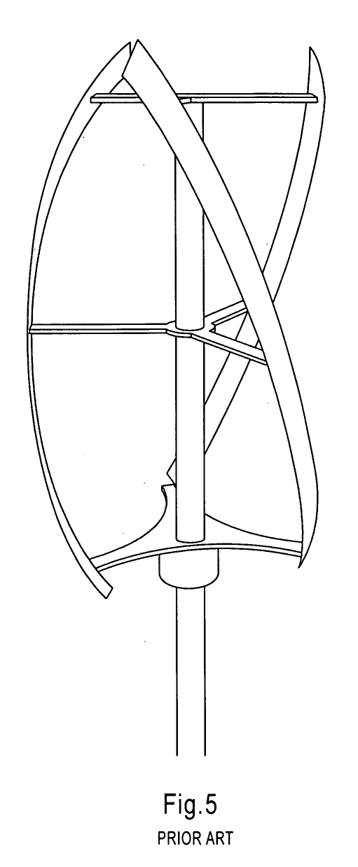

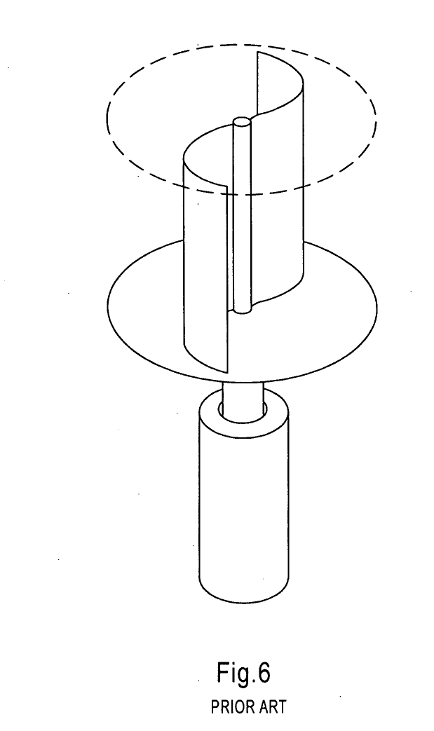

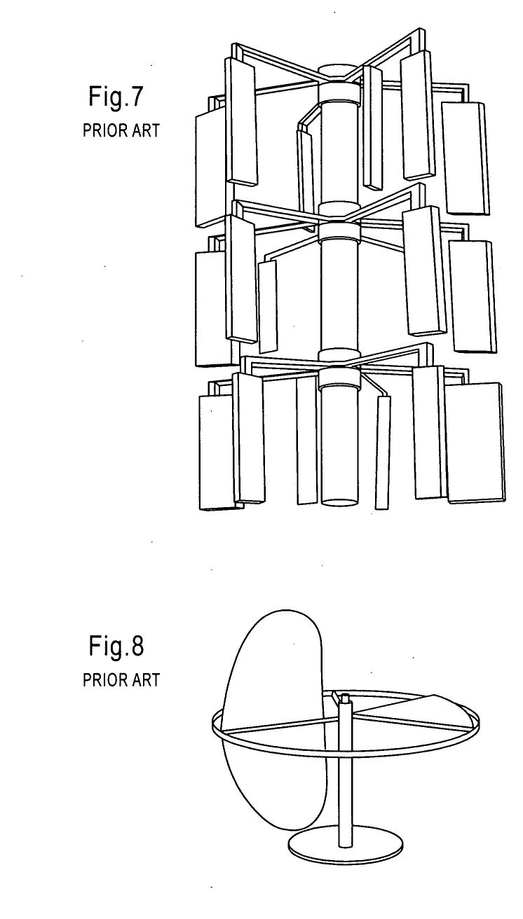

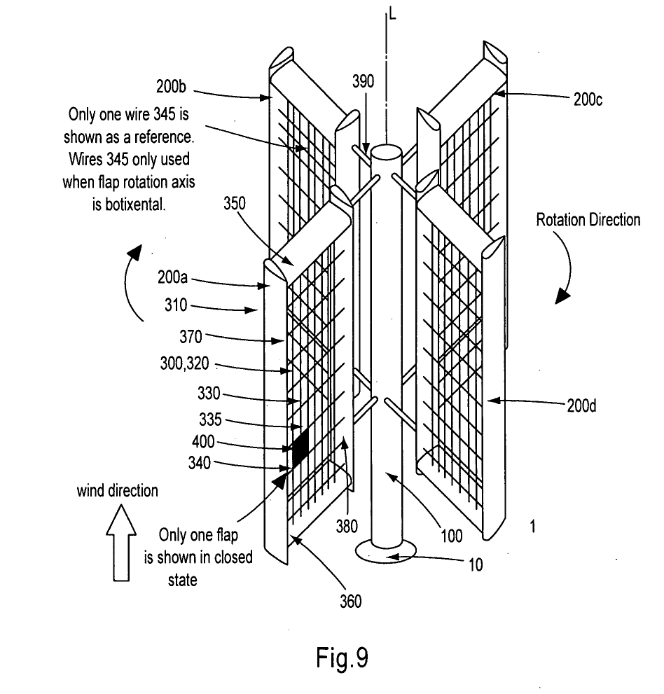

### DETAILED DESCRIPTION OF THE PREFERRED EMBODIMENTS

In this application, positive and negative faces of a sails and a sub-sail are mentioned. By positive face, it is meant that the wind hits the sail or the sub-sail in a direction perpendicular to a sail surface, wherein the flaps are in a CLOSED position in that face. On the other hand, by negative face it is meant that when the wind hits the sail or the sub-sail in a direction perpendicular to the sail surface, the flaps are in an OPEN position in that face. Furthermore, a positive motion of the sail, for example, is used to indicate the sail is moving in a same direction with the direction of the wind. A negative motion of the sail means that the sail is moving against the wind direction. For example, by these conventions, when the sail is undergoing the positive motion, wind is acting on the positive face of the sail. On the other hand, when the sail is undergoing the negative motion, wind is acting on the negative face. Since the marine check-valve turbine described herein is a drag type turbine, there are wind drags acting on the sails. By convention, a positive drag will be described as drag generated on the positive face of the sail when the sail undergoes a positive motion, while a negative drag will be generated by the negative face of the sail undergoing a negative motion. The challenge for the drag type wind turbine designer is to make the positive drag as large as possible and keep the negative drag as small as possible. The useful power generated by the drag type turbine is proportional to the magnitude of the difference between the positive and the negative drags.

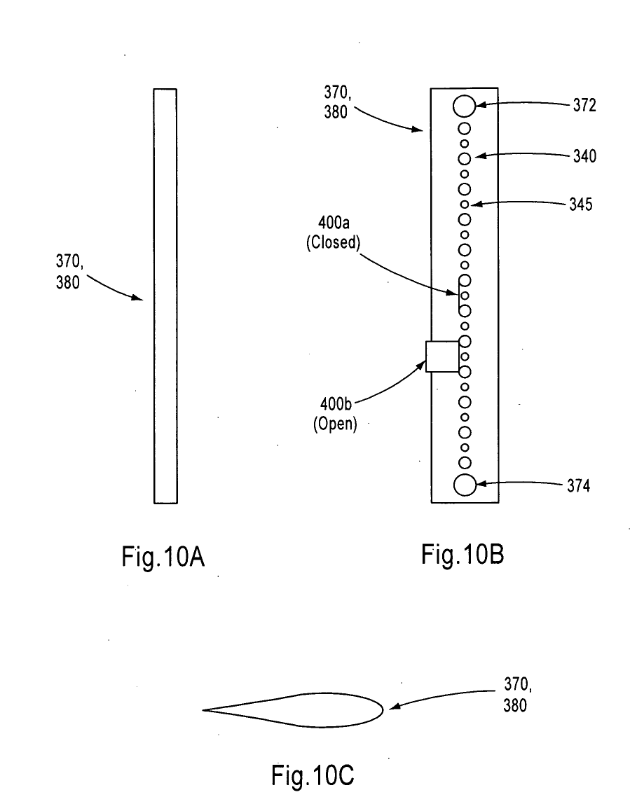

FIG. 9 illustrates an exemplary embodiment of the present invention. The VAWT assembly 1 of the present invention includes an assembly base 10, a vertical member or main shaft 100 coaxial to an axis L of the assembly 1 and a plurality of sails 200a, 200b, 200c and 200d. Although four sails 200a-d are illustrated, it is within the scope of the present invention to include any number of sails ranging from two (2) to n, wherein n is an integer greater than 2 and less than 721, depending on the design and intended use of the VAWT. Because each sail 200a-d is structurally identical to one another, only one sail, 200a will be described herein to avoid redundancy.

The sail 200a has a grid like structure to form a sail base which supports a plurality of moving flaps 400. It is within the scope of the present invention to include any type of suitable grid base that is able to support the moving flaps 400. In FIG. 9, only one flap 400 is shown in a closed state. While not intended to limit the scope of the invention and merely to provide an example of the various designs that are to be considered within the scope of the invention, the grid base can be designed with a wire grid, a flexible net like structure, and the like, and can be made of metal base, a wood base, a polymer base, a plastic base, or a base manufactured form any other known or future developed base having rectangular or any other geometric shaped holes thereon.

To facilitate understanding of the current invention, the description of the sail 200a will be provided hereafter using a sail having wire mesh substructure. The sail 200a includes a grid substructure 300 which has an outer frame 310 and a lattice body structure 320 which is comprised of intersecting vertical members 330 and horizontal members 340. The outer frame 310 includes a top horizontal member 350 and a bottom horizontal member 360 that opposes the top horizontal member 350 and is parallel relative to thereto. The outer frame 310 also includes first side vertical member 370 and a second side vertical member 380 that opposes and is parallel relative to the first side vertical member 370. The first and second side members 350 and 370 are orthogonal relative to the top and bottom horizontal members 350 and 360, respectively. Outer vertical frames 370 and 380 have an airfoil cross section such that these frames act much like the Giromill described before.

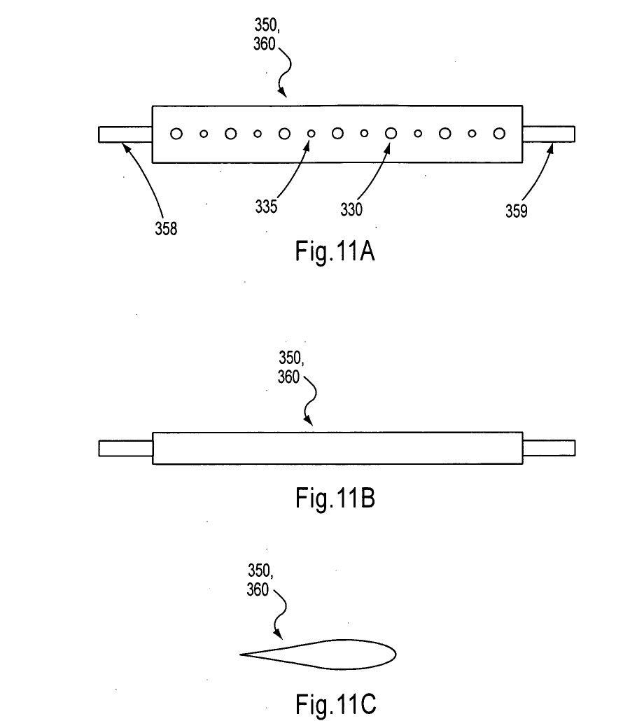

FIGS. 10A, 10B, and 10C show the vertical frame 370 from a front view, side view and a top view, respectively. The upper and lower frames 350 and 360 are connected to the side frames at holes 372 and 374, respectively. The horizontal wires 340 are also shown in FIG. 10B. The smaller wires 345 are the support wires which prevent the flexible flaps 400 from passing through the mesh. It is also within the scope of the present invention for the flaps 400 to be manufactured from rigid material. When the flaps 400 are made from a rigid material, the wires 345 are not needed. The flaps 400 are attached to the grids and cover the grids. In FIG. 10b, one flap 400a is shown in a closed position and another flap 400b is shown in an open position wherein the wire 330 (shown in FIG. 9) serves as a rotation axis of the flaps 400a and 400b. As can be seen in FIG. 10C, the cross section of the vertical frame 370, 380 is like an airfoil.

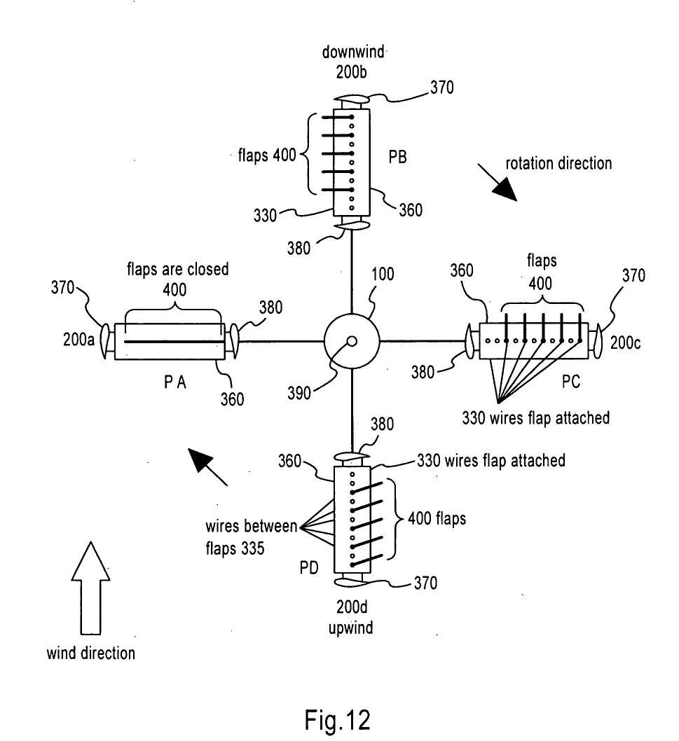

FIGS. 11A, 11B, and 11C show the lower or upper 360 or 350 frame from a top view, front view, and side view, respectively. Extensions 358 and 359 protruding from ends of the frames 350 and 360 are used to join the lower and upper frames 360 and 350 to the side frames 370 and 380. The vertical wires 330 are shown with big circles while the small circles represent wires 335 which will be used as support wires if the flaps 400 are made from flexible material. The flaps 400 are attached to the grid defined by the wires and cover the metal grid. As stated above with respect to the vertical frame, the cross section of the lower and upper frames 360 and 350 is like an airfoil or airplane wing's cross section, wherein during operation of the turbine, lift forces generated by the wind will compensate the weight of the sail 200a so that less force exerted on bearings.

As noted above, the vertical wires 330 or horizontal wires 340 can be the rotation axis of the flaps 400 depending on how the flaps are attached to the grid. For example, if the flaps 400 are arranged on the vertical wires 330, the vertical wires 330 will serve as the rotation axis. However, if the flaps 400 are arranged on the horizontal wires 340, the horizontal wires 340 will serve as the rotation axis of the flaps 400. If the flaps 400 are not made from a rigid material, then support wires 335 (or 345) should be put between the wires 330 (or 340). Depending on the construction of the sail, there may be one or more extra lines or wires extending in the horizontal or vertical direction. The wires 335 or 345 will be thinner than the wires 330 and 340 because they will not have to carry the weight of the flaps 400. The purpose of the wires 335 and 345 is to prevent the flexible flaps 400 from passing through the grid, which would cause the mechanism not to function properly.

The number of the support wires 335 or 345 can be from 1 to n, wherein n is an integer greater than 1 but less than ten (10) million. However the lower the value of n, the less the sail 200a will weigh. It should be noted that there is no need for the support wires 335 and 345 if the flaps are made from a rigid material. In instances where the flaps 400 are manufactured from a solid or non-flexible material, the distance between the parallel wires 330 or 340 will be less than the length of the flaps, which will prevent the flaps 400 from rotating more than 180 degrees, thereby allowing the flaps 400 to stay on one side of the sail. The support wires 335 and 345 are only required for flexible flaps 400 which are able to pass through the rotation wires with the force of the wind during the operation of the turbine. In either case, the flaps 400 may be restricted from full motion by restriction wires 335,345 on the frame 310. While the flaps 400 change from closed to open positions and back, the speed of the action may create noise. By bringing the restriction wires 335,345 closer to the center of rotation of the flaps 400, or placing rotation restrictors (to be described later) on the rotation tube or wire, the noise can be substantially reduced because the speed in which the flaps 400 hit the restriction wires 335,345 is reduced.

The sail 200a has a sub-grid structure wherein the flaps 400 operate as a check valve for the sail 200a. The flaps 400 are arranged in such a manner that during the downwind direction, the flaps 400 are in the closed position, and when in the upwind direction, the flaps 400 are in the open position. It will not be necessary to have a mechanism to open and close the flaps 400, as the open and closed state of the flaps 400 is controlled by their design, how they are arranged, and the direction of the wind.

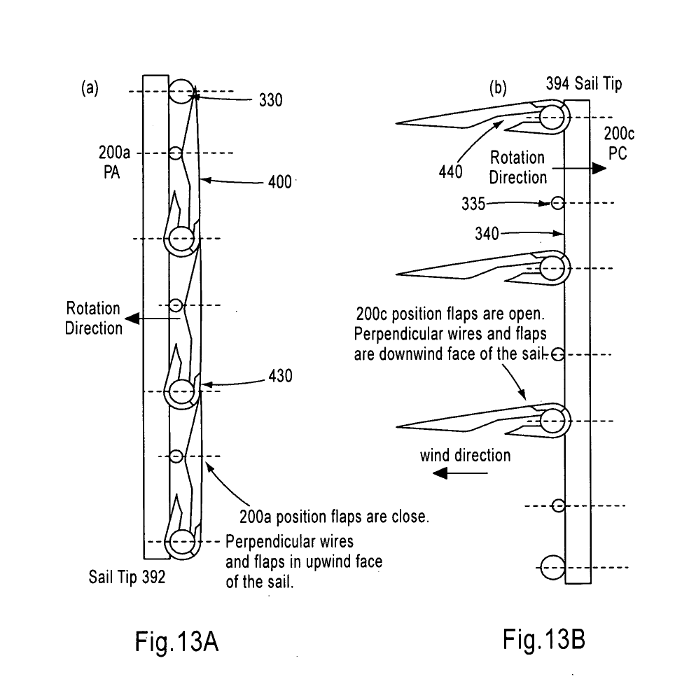

FIG. 12 shows all of the sails 200a-d from a top or plan view of the assembly 1 and can easily determine the direction of the wind and rotation of the assembly 1. Sails 200a and 200c are perpendicular to the wind direction, wherein sail 200a is moving in the downwind direction, and sail 200c is mowing in the upwind direction. On the other hand, sails 200b and 200d are aligned with the wind direction.

To make the description easier to understand, four positions in FIG. 12 are defined wherein the position of the sail 200a is defined as PA (Position A) and the other sail positions are described as PB, PC and PD, respectively.

As shown in FIG. 12, at PA, the flaps 400 are closed and their rotation axis is the wire 330, while the wires 335 (if flaps are flexible or not overlapping) prevent the flaps 400 from going through the holes by the intersecting wires 330 and 335, respectively, even if there is a heavy wind force acting upon them. The flaps 400 are also overlapping one another so that air does not and will not pass between them. The air does not pass between the flaps 400 because the flaps 400 are dimensioned to be longer than a distance between the parallel wires 330. The flaps 400 are attached to the wires 330 where they are further away from rotation axis L of the main shaft 100, which is shown as a white circle 390 at the center of the main shaft.

When the flaps 400 leave PA and arrive in the downwind location at PB as shown in sail 200b, the flaps 400 begin to rotate about the rotation axis and are in a slightly open to fully open state. Then, when the flaps 400 leave PB and arrive at PC, as shown in sail 200c, the flaps 400 completely rotate about the rotation axis and are in the fully open state. The reason for this is that when the sail 200c is in the upwind rotation, there is a pressure on the side of the sail 200c facing the wind, while there will be a suction force in a downwind face of the sail 200c. it should be noted that the restriction wires 335 are located in the upwind face of the sail.

The combined effect of the pressure, suction and the location of restriction wires 335 force the flaps 400 to open. In short, retention wires 335 prevent the flaps 400 from opening in the downwind direction, while allowing the flaps 400 to move freely in the upwind direction. Based on the above description, the flaps 400 act as a check valve for the assembly 1 without requiring a mechanism to open and close the flaps 400 and the wind is doing all the work.

Moreover, the opening and closing of the flaps 400 is controlled by the wind, therefore the motion of these flaps 400 will appear to be random when in the partially to nearly fully open state. Since the size of the sails 200a-d will need to be large enough to produce a useful amount of energy, the wind will “strike” the flaps 400 of the sails 200a-d with varying force, coming from varying directions, and at different parts of the sails 200a-d.

The restriction wires 335 adequately retain the flaps 400 when the corresponding sail 200a-d is in a downwind location (e.g., PA). However, when any one of the sails 200a-d is moving toward the upward direction (e.g., PC to PD), the flaps 400 move in any direction on the downwind face of the sail 200c. The apparently random motion of the flaps 400 should be controlled so that the flaps 400 are operating properly. This can be achieved in many ways, such as, for example, when using flaps 400 made of flexible material, a string can be attached to tip of each flap 400 connecting the flap 400 to a base of the mesh such that the string wont allow the flap 400 to rotate more then 90 degrees relative to the face of the sail 200a-d. If the flap 400 is manufactured from a rigid or non-flexible material, it is envisioned that the rigid nature of the flap 400 will suffice to control the flap 400, however, it is within the scope of the invention for the designer of the assembly 1 to configure a mechanism (if deemed necessary) to control the flap 400.

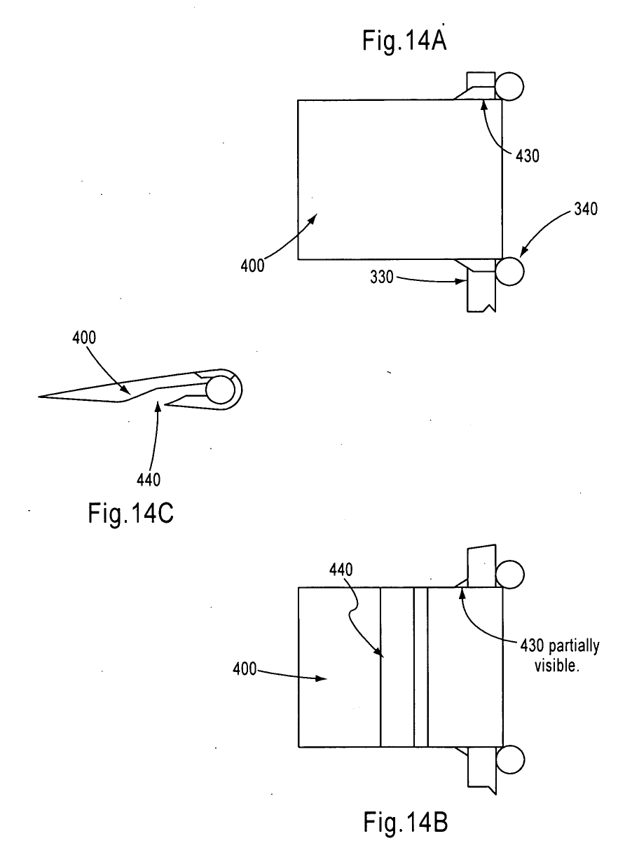

FIGS. 13A and 13B also illustrate how the flaps 400 operate. To better understand the following description, it should be presumed that the wind direction is from right to left when viewing FIGS. 13A and 13B. FIG. 13A shows the flaps 400 in a fully closed position, that is, PA in FIG. 12 and FIG. 13B shows the flaps 400 in the fully open state, that is, PC in FIG. 12. it should also be noted that the cross-section view of the flaps 400 in FIGS. 13A and 13B are merely illustrative and that the flaps 400 are envisioned to have any suitable configuration that will allow the flaps 400 to rotate about their respective rotation axis and be able to “capture” the wind while the sails 200a-d are rotating about the main shaft 100. It should also be noted that when the sail 200a at PA rotates to position PC, the wire configuration will be similar to the sail 200c at PC.

As shown in FIG. 13B, the flaps 400 include at least a clasp member 440 used to removably attach the flaps 400 to the corresponding wires, and an extended portion 430, shown in black, which limits the rotation of the flaps 400 to 90 degrees and are hereinafter referred to as rotation restrictors 430. The rotation restrictors 430 play a vital role when the centrifugal forces and air speed experienced during rotation of the assembly 1 forces the flaps 400 to open as much as possible as the extended portions limit the extent of the flaps 400 rotation about the rotation axis. In this configuration, when the sails 200a-d are at their lowest position PB and highest position PD with respect to the wind, the sails 200a-d will operate as a drag base wind turbine at position PA and operate like a lift sail type wind turbine at the PB and/or PD positions.

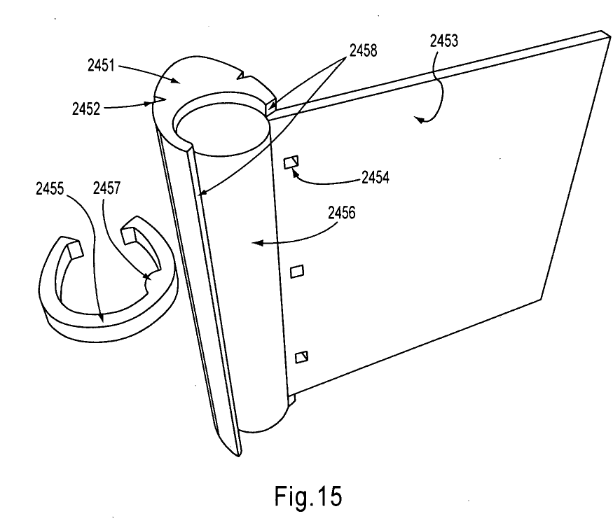

FIGS. 14A and 14B show the flaps 400 in the open position from the top and bottom views, respectively. The rotation restrictors 430 react with the wire 340 to prevent the flap 400 from rotating more than 90 degrees relative to the wire 340. As stated above, the clasp member 440 is used to mount the flaps 400 on to the wire 330. FIG. 14C provides a side view of the flap 400 for reference to FIGS. 14A and 14B.

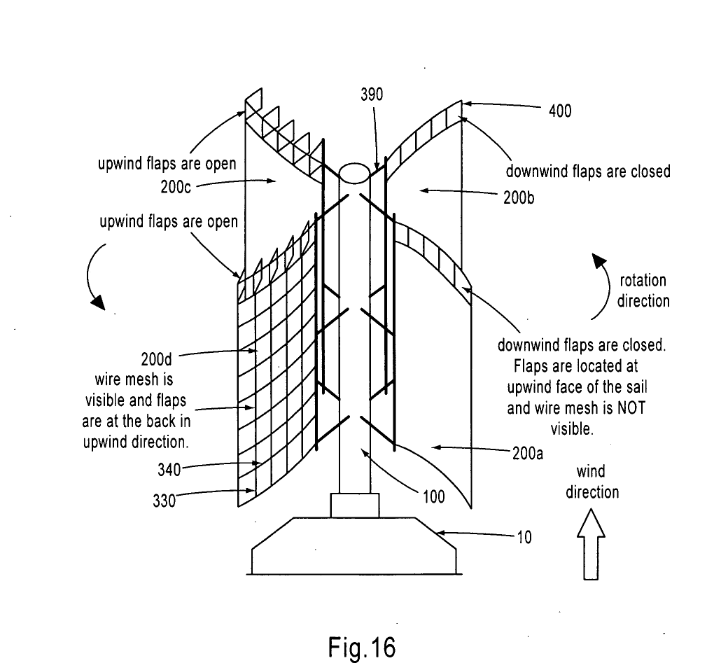

It is not necessary for the flaps 400 to rotate around the wires 340. For example, in some circumstances it may be advantageous to rotate the flaps 400 in extruded grooves, as shown in FIG. 15. The flap rotation axis 2456 may be placed on an extruded aluminum profile 2451, for example. In order to hold the flaps 400 on the extruded aluminum profile 2451, a snap ring 2455, which may be made of plastic or any other suitable material, may be pushed through a hole 2454 to snap fit in grooves 2452. In order to further secure the position of the flap 400, circumferential grooves (not shown) may be provided on the flap 400 to hold the snap rings 2455 in place. Extension 2457 may be used to close the gap between the snap ring 2455 and rotation axis 2456 of the flap 400. Because the diameter of the rotation axis 2456 of the flap 400 is smaller then the diameter of the snap ring 2455, extension 2457 will compensate for this difference and hold the flap 2453 securely in place.

Rotation angles may be restricted by construction of the extruded aluminum profile 2451. For example, as shown in FIG. 15, rotation is restricted to 135 degrees, which is beneficial under certain circumstances because it's much like giving an extra push to the sail when the sail is in transition from the downwind direction to upwind direction. By restricting the rotation to 135 degrees, the flap 400 can be used to generate thrust beyond its lowest position in the downwind rotation just when it is about to begin its upwind motion. In these positions, the flaps 400 act like a race car back flap which pushes the car downward. In the turbine, this force will create extra rotation moment. Other possible benefits of this design may be the elimination of rotation restrictors. Because the flaps 400 are not touching anything (like rotation restrictors) and the impact of the flap 400 to tube edge 2458 occurs in lower velocities when it is switching from the closed position to the open position, a reduction in noise may be achieved. Using lightweight material, such as aluminum, allow for a lighter design because the hollow tube is lighter and the restrictors may be eliminated, further reducing weight. Mounting and dismounting of the flaps 400 may be faster and the flaps 400 themselves may be cheaper to manufacture.

The present invention may be considered a hybrid between the Giromill and Darrieus designs of a VAWT. As shown in FIG. 12, the invention creates a maximum torque at position PA of the sail 200a, however, Giromills create maximum torque when the sails are at the PB and PD positions. Since this invention works much like the Giromill and Darrieus designs, it will generate torque at PA, PB and/or PD positions. In the present invention, it is believed that a torque is generated for over half of the rotation sweep of the assembly 1 except in the vicinity of the PC position.

An advantageous alignment for the flaps is for the rotation axis to be vertical because it will create the Giromill effect; however this position is not a requirement. There may be some applications which may require different arrangements. It may be desirable to arrange the flaps 400 horizontally. In the vertical alignment the opening and closing of the flaps 400 are done by the wind, however in the horizontal alignment the closing of the flaps 400 will be accomplished by gravity while the opening of the flaps 400 will be done by the wind. When the sails are moving from position PA to position PB, the flaps 400 will begin to open prematurely, however this premature opening will not cause power loss due to the Giromill effect. The premature opening of the flaps 400 may cause some noise and since noise is not desirable, it should be prevented.

If the flaps 400 are arranged in the horizontal rotational axis, wind will not be able to open the flaps 400 very easily when the sail is in the PB position because of the flap configuration. Due to the horizontal alignment of the flaps 400, the flaps 400 will be in a closed configuration around the PB position. However, when the sail is approaching the PC position from the PB position, the strength of the wind will cause the flaps 400 to open automatically. The opening process will gradually occur such any creation of noise will be reduced.

Wind will be stronger upon an upwind sail, position PC, than a downwind sail, position PA, because while wind is blowing downwind the sail in position PC is moving in the upwind direction. Therefore, the relative wind speed with respect to sail at position PC will be the speed of the wind plus the speed of the sail. On the other hand when the sail, in position PA, is moving in the downwind direction, the relative wind speed with respect to the sail at position PA will be the wind speed minus the speed of the sail. This is one of the main reasons why some VAWTs are inefficient, the upwind moving sail creates so much drag that the system fights against this drag instead of producing valuable energy. By opening the flaps 400 on the upwind direction, drag will be reduced substantially, thus increasing the overall system efficiency.

It is also within the scope of this invention that the alignment of the flaps 400 be oblique rather than horizontal or vertical. In this embodiment, the opening of the flaps 400 will be done by the wind while closing of the flaps 400 will be done by the combined effects of gravity and wind. The orientation of the oblique angle will determine whether wind or gravity will be stronger.

The rotation axis of each flap 400 can also be at any location as long as it performs the check valve function against the wind. Therefore, the flaps 400 will be closed in the downwind and open in the upwind direction, a key principle of this invention.

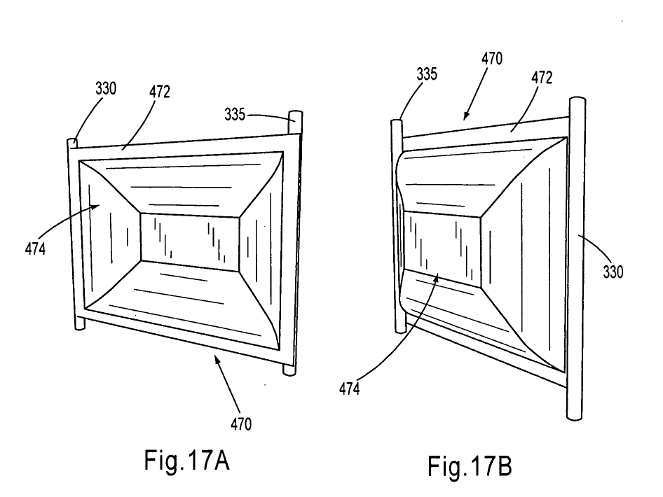

The grid structure composed of wires 330 and 340 can also be arranged such that they create a curved sail much like a scoop. FIG. 16 shows the arrangement of a rigid sailed VAWT where the sails have a curvature allowing them to have a scoop-like structure. Unlike the above described turbine, which rotates clockwise (CW), the turbine assembly of this embodiment rotates in the counter clock wise (CCW) direction. Turbines can be arranged to rotate in any direction simply by rearranging the sail structure.

With this invention, the design of the VAWT can be handled in many ways. It is not necessary that the sub-grid 320 be a wire and the flaps 400 be made of semi rigid material. It is within the scope of this invention to design a VAWT where the sub-grid is rigid and the flaps 400 are flexible. It is also equally possible to have both the sub-grid and flaps be flexible.

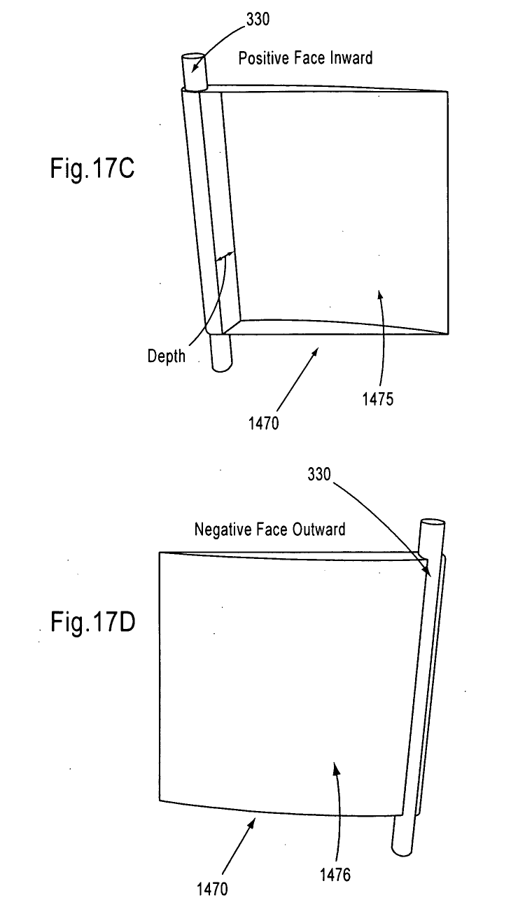

For example, FIGS. 17A and 17B show a flexible membrane flap 470 for increasing the efficiency of capturing the force of a fluid in a downstream direction. The membrane flap 470 has rigid frame 472 that surrounds and supports a puncture-resistant, flexible membrane member 474. The membrane flap 470 may rotate around the vertical wire 330, for example, while the restriction wire 335 supports the rigid frame 472 in a closed position. The flexible membrane member 474 bends inward and creates a bucket shape which creates a greater drag in the path of a fluid. The membrane flap 470 increases the efficiency of the check-valve turbine in a manner similar to, but greater than, the Savonious curved turbine sails. Fluid collected in the bucket shape of the membrane member 474 is pushed outward toward the end of the downstream motion which generates an extra push for the sails. The fluid filled membrane member 474 may also prevent the membrane flap 470 from moving to an open position prematurely which may reduce noise. On the upstream stroke, the membrane member 474 will return to its original shape and reduce drag while the flap 470 is open. FIG. 17B shows the membrane flap 470 from behind when filled by fluid in a downstream direction.

FIGS. 17C and 17D show another aspect of the invention in which rigid square scoop shape plastic flaps 1470 may be provided to function in a similar manner as the membrane flaps 470 described above. It should be emphasized that the depth of the scoop portion 1471, as shown in FIG. 17C, should not be larger than the projected area of the flap 1470 around the wire 330, for example. The thickness of wire 330, plus the thickness of the plastic around the wire 330, should determine the maximum depth of the scoop portion of the scoop flap 1470. The scoop flap 1470 may reduce manufacturing costs while maintaining the effectiveness of a membrane flap. In FIG. 17C, a positive face 1475 is the face of the flap 1470 as viewed in the closed position in a downward motion (PA). FIG. 17D is a view of the negative face, or the back face 1476, of scoop flap 1470, wherein the back face 1476 has a curving profile.

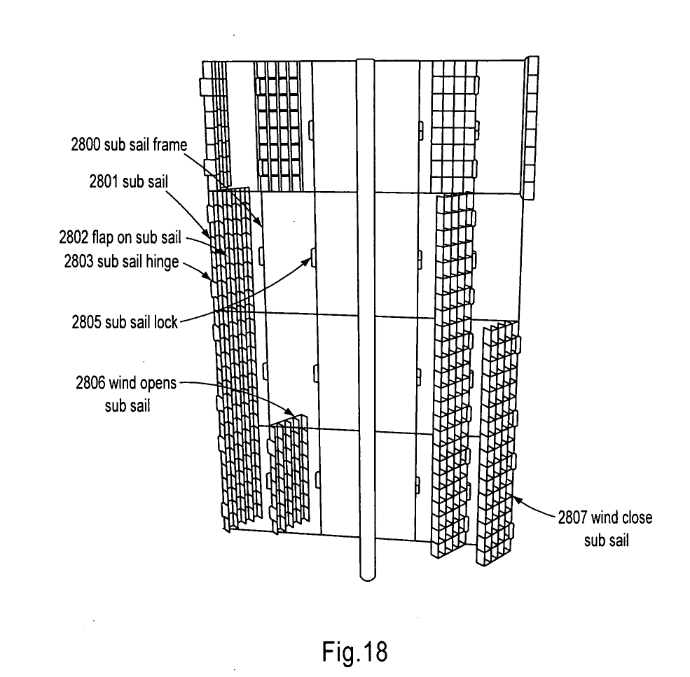

FIG. 18 assembly illustrates a sub-grid in which the sail 2800 is comprised of sub-sails 2801. Any power producing rotational machine should have a mechanism to stop the machine completely under extreme conditions or for maintenance. For example water or steam turbines cut the water or steam supply coming to these turbines to stop their operation completely. The bladed horizontal wind turbines have pitch motors which changes the orientation of the blades to that of the least resistant position and uses braking power to stop the machines. A check-valve turbine without such a mechanism would be useless, since there is no way of stopping the machine under extreme conditions or for maintenance purposes, during extremely windy conditions. To use a braking system, without force reduction, on the sails will require a very expensive mechanism to stop the turbine. To overcome this difficulty, sails will be constructed with sub-sails attached to them.

If a sail resembles a rectangular wall, then sub-sails are much like doors attached to the wall. The flaps 2802 are attached to the grid on each individual door. The doors are able to rotate 90 degrees on the sails, while the flaps 2802 are able to rotate 180 degrees on the grid attached to the door. For optimum performance, the rotation axis of the doors and flaps 2802 should be parallel; however, this is not a requirement. FIG. 18 illustrates an example of a wind turbine not in operation during the maintenance state when there is no wind acting on the turbine. Some of the sub-sails 2801 are removed to show the underlying sail frame 2800 which holds the sub-sails 2801. In this example, the sub-sails 2801 are attached to a sub-sail frame 2800 by sub-sail hinges 2803. Sub-sail locks 2805 hold the sub-sails 2801 in the closed position during normal operation of the turbine and are able to rotate 90 degrees when the locks 2805 are released. The locks 2805 may be released during maintenance and extreme weather conditions to cease operation of the turbine. During regular operation, the locks 2805 will not allow the doors to swing, thus sail and sub-sail 2801 will act as regular sails. When there is an emergency, the locks 2805 may be released by an electronic mechanism to let the sub-sail 2801 swing (or rotate) freely. Once the locks 2805 are released, there is no way the turbine can maintain rotation, because upwind sail flaps 2802 are open and do not show any resistance to the wind. At the same time, downwind, the sub-sails 2801 open and there is no resistance to the wind. A braking mechanism may be further provided to stop the turbine completely and prevent the injury of personnel, for example, if the wind changes direction suddenly, which might cause the turbine to make some movement but not complete a rotation.

The flaps 2802 are attached on the sub-sail 2801 and are able to rotate up to 180 degrees. The open sub-sails 2801 may be brought to the closed position with a self closing mechanism similar to those used on self closing doors, such as a spring-loaded hinge or air-controlled piston (not shown), for example, or by tilting the sub-sail frame 2800 to some appropriate angle which would cause the sub-sails 2801 to close by gravity.

A rubber-like shock absorber (not shown) may be attached to the sub-sail frame 2800 to protect the sub-sails 2801 from damage in case they strike the sub-sail frame 2800. Also, the sub-sails 2801 may be designed to open rapidly, while closing may be slower and gradual to reduce the chances of the door slamming and becoming damaged or creating a lot of noise.

When the strength of the wind is reduced from dangerous levels but still has some strength, the sub-sails 2801 on the upwind side of the sail may be closed by the self closing mechanism; since the flaps 2802 on the sub-sails 2801 would be in an open condition. However, the sub-sails 2801 attached on the downwind sail will not be closed. This is because the flaps 2802 are closed in this position. While the self closing mechanism may push the sub-sail 2801 toward a closed position, the wind will try to maintain the sub-sail 2801 in an open position due to closed flaps 2802. This will make the turbine inoperable. To overcome this, a motor may be provided on the turbine axis to give the turbine a 180 degree rotation, which will force all the sub-sails 2801 to the closed position and allow the turbine to be operable again.

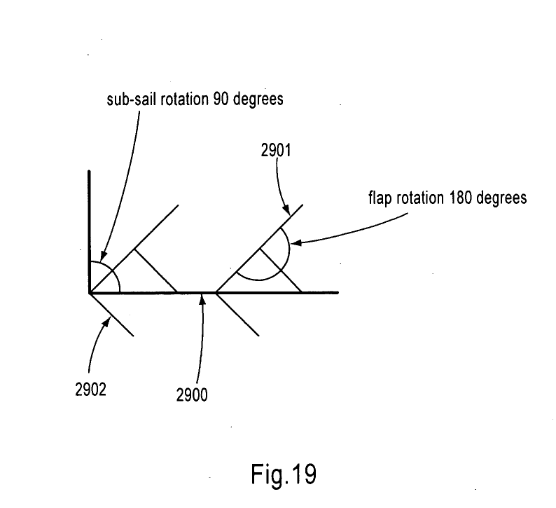

FIG. 19 shows the top view of a sail 2900 with 2 columns of sub-sails 2901 attached. FIG. 19 also shows two columns of flaps 2902 attached to the sub-sails 2901.

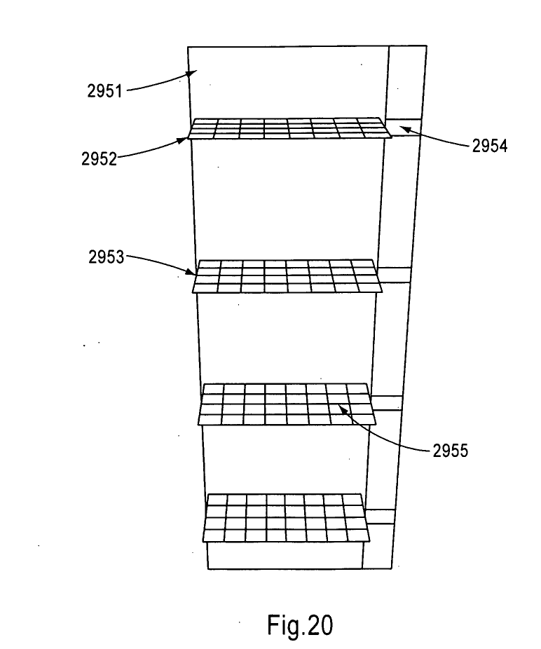

While the door-like sub-sails 2901 may be easy to construct and operate, they may not be appropriate for particular applications. For example, a boat operating with a check-valve turbine may not be suitable for operation, under certain conditions, with door-like sub-sails. The waves in the ocean may make the sub-sails act violently. Rotating sub-sails 2952, similar to those shown in FIG. 20, may be implemented. In this configuration, rotating sub-sails 2952 are attached to the sail frame 2951 by a rotation bearing 2953 and rotation motor 2954. The sub-sails 2952 may rotate on a horizontal axis such that when they are rotated, the sub-sail surface may be generally parallel to a horizontal plane. As shown in FIG. 20, during extreme wind conditions, the motor 2954 may rotate the sub-sail 2952 ninety (90) degrees to an open state. When the wind speed is reduced from dangerous levels, the motors 2954 may rotate the sub-sail 2952 ninety (90) degrees in an opposite direction to bring the turbine to normal operating conditions. Although described above with a specific range of motion, the sub-sails 2952 may rotate 360 degrees in any direction to provide maximum flexibility to the sub-sails 2952.

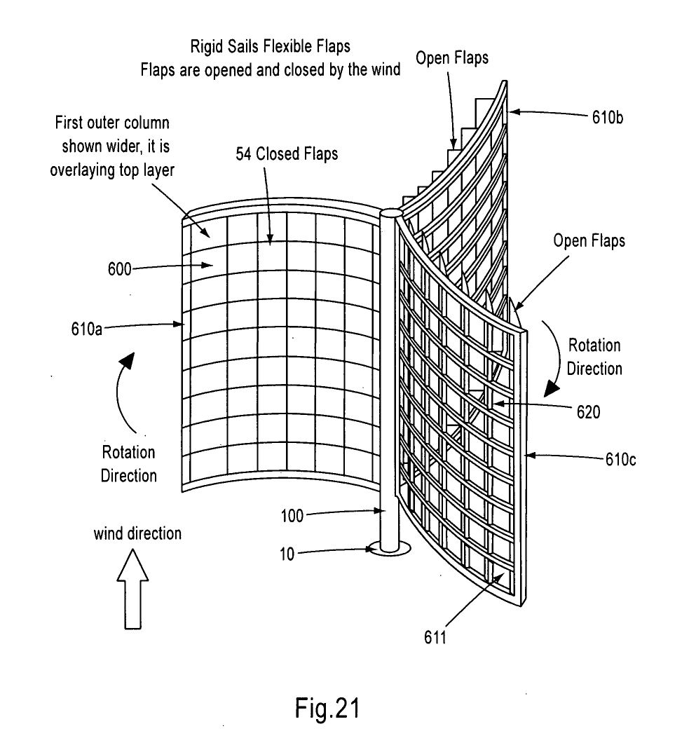

FIG. 21 illustrates according to yet another embodiment of the sail 200a where the underlying grid is made of suitable material (metal, plastic, etc.) with holes 611 on it for the wind to pass through in the upwind movement of the sail. In this case, the flexible flaps 600 are attached to the sub-layer grid by an adhesive, e.g., a glue, or any other suitable adhesive mechanism. The flexible flaps 600 should be made of bendable material unlike the flaps 400, which are made of semi rigid material. The bendable material for the flexible flap 600 can be rubber, plastic, leader, Kevlar or fabric. Note that the flexible flaps 600 are not rotating but are attached to the grid from one edge of the flap and that the opening and closing of the flap is accomplished by the bending of the flexible flap 600 by the wind.

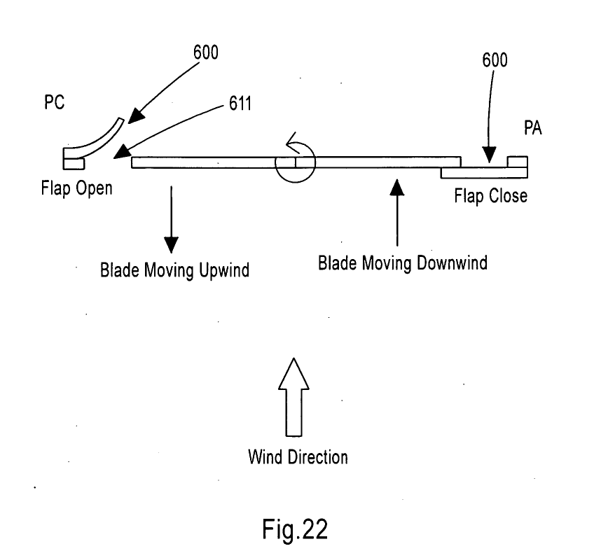

FIG. 22 is a plan or top view of a flexible flap 600 attached to a rigid base and which is not able to freely rotate. Rather, in this embodiment, the flaps 600 restrain themselves from rotating more than 90 degrees. It is important to note that the flaps 600 are flexible enough to bend, yet strong enough to cover the hole 611 without passing through to the other side. The flaps 600 close the holes 611 simply by being in a closed position because the flaps 600 are dimensioned to overlap the hole. To further prevent the flexible flaps 600 from passing through the holes 611, a coarse mesh may be attached to the holes 611.

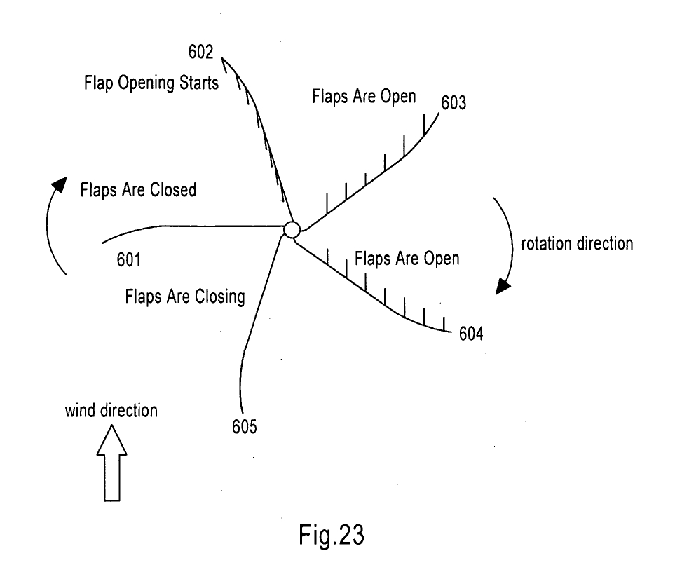

FIG. 23 is a schematic diagram of a plan or top view of a VAWT with five rigid sails having flexible flaps. FIG. 23 shows how each of the sails operate at different positions during the rotation lifecycle. The flexible flaps 600 are attached to the sail perpendicularly such that while in position 601, the flaps 600 are in the fully closed state; when in position 602, the flaps 600 are in the partially open state; when in positions 603 and 604, the flaps 600 are in the fully open state, and in position 605, the flaps 600 are again in the fully closed state. It is important to note that the flexible flaps 600 should be larger than the holes 611, otherwise the wind may force the flaps 600 through the holes 611 and make the sails inoperable. If necessary, some type of wire or net may be added to prevent the flexible flaps 600 from passing through the holes 611.

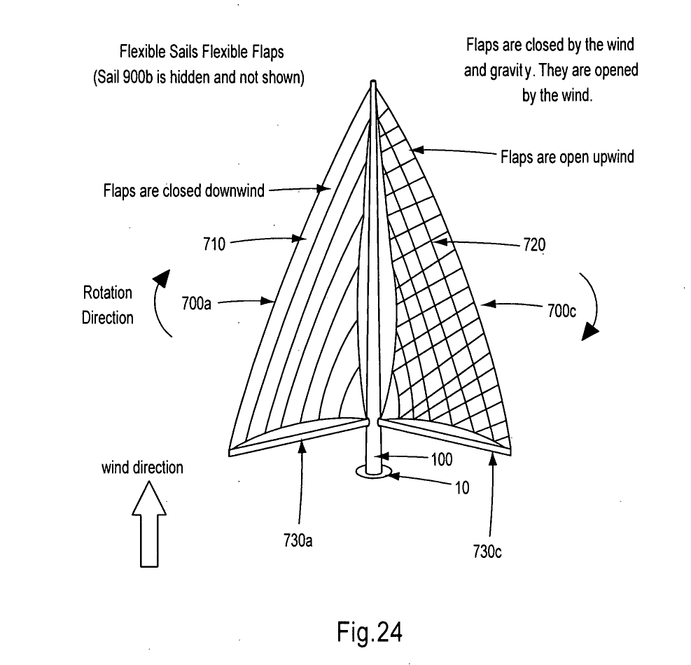

It is also possible that both the sails and flaps are made of flexible materials. Actually, it is suitable, or alternatively, for some application to have flexible sails. FIG. 24 illustrates yet another embodiment of the present invention wherein a flexible sail is used with a sail boat to power the boat. This kind of construction will be similar to commonly known single-layer sailboat sails, but wherein the sail is made of two layers instead of the conventional single layer sail. In this embodiment, the base grid will be similar to a net 720 having flexible flaps 710 attached thereon.

Rather than having solid sails, the sails may be built with flexible material, as illustrated in FIG. 24, to allow the sails to be foldable so that in case of a storm, the boat will not be subjected to too much force. The sails may have a grid sub-layer 720 made of net and the flaps 710 may be attached thereto at an oblique angle wherein gravity and the wind will close the flaps in the downwind rotation. On the upwind rotation, the flaps 710 will be opened by the wind to reduce the drag on the sail. As shown in FIG. 24, the third sail 700b is hidden from the view. The sails used to propel the boat rather than push the boat, as is the case with conventional sailboats.

This simple structure can also be used with irrigation and other power requiring systems where such turbines can be manufactured using local resources and without requiring expensive material.

Until this point, each of the embodiments of the inventive VAWTs described herein have two layers on the sail to create the check valve action and to enable the turbines to work properly wherein the first layer is a mesh like structure and the second layer includes the flaps operating on the mesh. The purpose of the mesh is to restrict the flaps from moving in unwanted directions. This design is easy to build, however it is not the only way to create a sail where the flaps act as a check valve. The primary emphasis of this invention is to have flaps act as a check valve. Therefore it is within the scope of this invention to have flaps act as a check valve whether there is an underlying mesh structure or not.

There are many ways to make the flaps act as a check valve and as an example, a sail where there is no mesh structure and the flaps alone act as a check valve will be described.

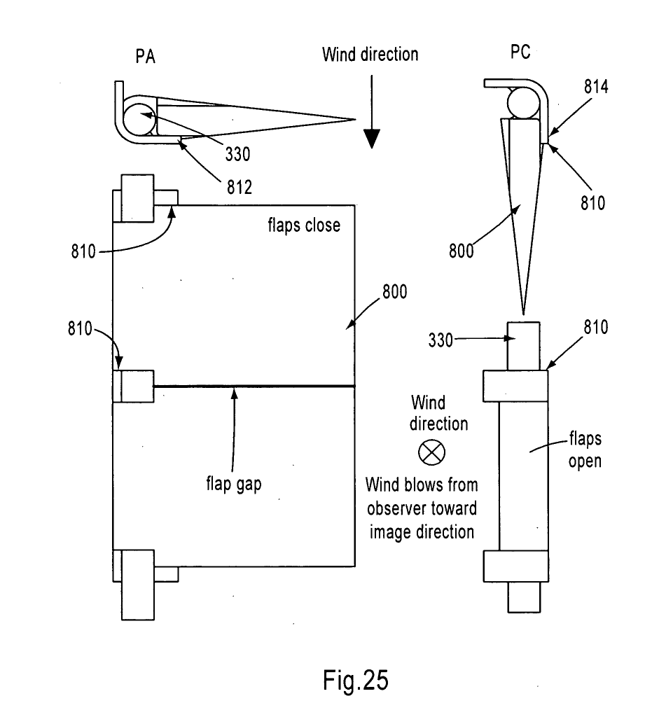

FIG. 25 shows a system where the flaps 800 act as a check valve. The vertical wires 330 will still be present with this arrangement, however; the horizontal wires have been replaced by an L-shaped strip 810, which plays the same role as the horizontal wires. The L-shaped strip may be made of any suitable material, including lightweight metals such as aluminum, for example. The L-shaped strips 810, which have a rectangular cross section (one side is longer than the other), have at least two functions. A function is to restrict rotation of the flaps 800 to 90 degrees. Thus, the restriction of rotation is shifted from the earlike structure 430 to the L-shaped strip 810 in this embodiment. Another function is to eliminate the horizontal wires 340, which were used to keep the flaps 400 equally spaced, vertically, from the system. The clasp member length 830 between flaps 800 is adjusted by the distance of L-shaped strips 810. Eliminating the long wires 340 with small L-shaped strips 810 substantially reduces the weight of the sails, makes it lighter, and is relatively easy to manufacture. This type of turbine also exerts enormous centrifugal force because the weight distribution of the sail is further away from main shaft 100. This is significant because any weight reduction has an enormous impact on overall system performance.

The operation principle of the flaps 800 is simple. When the sail is in the PA position, wind forces the flap 800 to close, and the arm 812 of L-shaped strip 810 prevents the flap 800 from moving more than a desired angle, regardless of whether the flaps 800 are overlapping or not. On the other hand, when the sail is in the PC position, the wind forces the flap 800 to open, but arm 814 of the L-shaped strip 810 will prevent flap 800 from rotating more than 90 degrees relative to the wire 330.

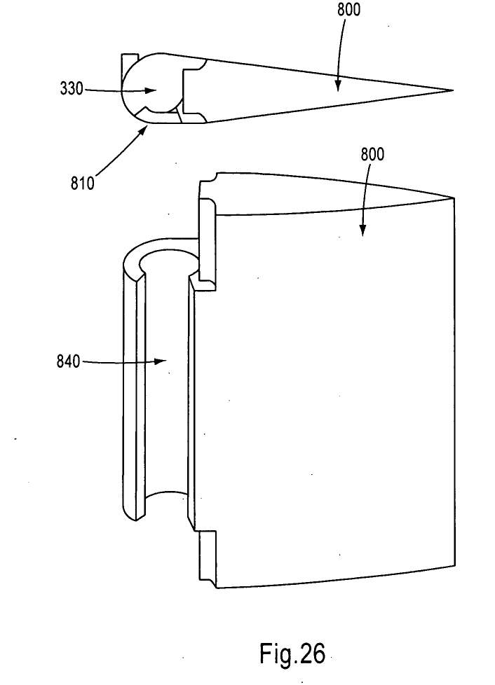

FIG. 26 shows a close up view of the flap 800. In this embodiment, the extension 430 is not present. Instead, the flap 800 has a section where the L-shaped strip 810 operates and the rotation hole 840 does not extend along the entire length of the flap 800 to make room for the L-shaped strip 810 to operate on both ends of the flap 800. In this embodiment, the clasp member 840 is different than the clasp member 440 discussed above. It is within the scope of the present invention to have any suitable attachment mechanism that permits the flap 800 to operate as check valve. It is also important to note that as a result of the structure and location of the clasp member 440, once the clasp member 440 grabs the wire, wind cannot dislodge the flap 800 therefrom. The flaps 800 may also be made of two rigid flaps screwed to each other around the wire.

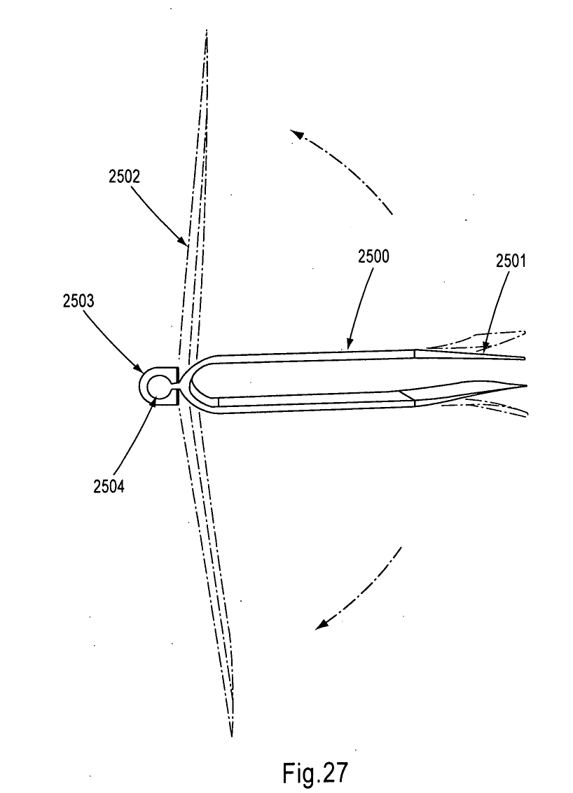

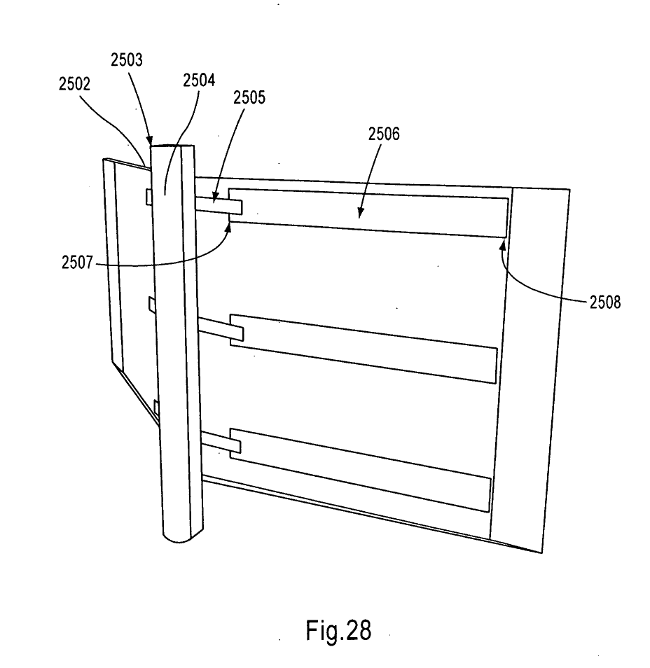

Furthermore, a flap 2500 may be provided that serves the check-valve principle without rotation about a wire or within a tube, for example. Rather, at least two panels 2502 of flap 2500 may attach to a main base 2504, as shown in FIGS. 27-28. The panels 2502 may be manufactured from an elastic material which can change its shape, or bend, as the result of the force of the wind, for example.

In FIG. 27 the flap 2500 is shown in 3 different stages. This type of flap operates best when the flap base 2504 is horizontal to the ground. The center position is showing the shape of the flap 2500 when there is no wind acting on the panels 2502 (manufactured position). Note that the free ends or tips (2501) of the panels are thinner and may be bent outward. This allows the air to enter easily and bend the elastic panels 2502 into an open position. When the flap 2500 moves against the wind, the panels 2502 are bending inward toward each other and create an airfoil shape which reduces the drag caused by the wind. When the sail is moving in the downwind direction, the flexible material bends and the panels 2502 open to capture the wind coming towards the sails. The flaps 2500 may be placed in an extruded aluminum profile 2503 where the longitudinal end of the profile 2503 nearest the panels 2502 is flat to act as a supporting base for the opened flaps and to restrict their rotation.

FIG. 28 shows that the aluminum profile 2503 may have fin like extensions 2505 to prevent the elastic panels 2502 from bending beyond a certain position. Because the panels 2502 are very elastic, the fin 2505 will not completely prevent the panels 2502 from bending backward. To further prevent backward bending, strips 2506 may be attached by glue, or any other suitable means, onto the panels 2502. The strips 2506 may be composed of a suitable material, including a lightweight metal or plastic, for example. The number of strips 2506 may be determined by experiment, taking into account the flexibility of the material, for example. The interior end 2507 of the strip 2506 closest to the aluminum profile 2503 may have be situated some distance from the center to allow the panel 2502 to bend easily. If the interior end 2507 went all the way to the center of the aluminum profile 2503, the panels 2502 would have difficulty bending inward. A section of fin 2505 may overlap the strip 2506 to give support to strip 2506 so that it does not bend backward when the panels 2502 fully open. The second end 2508 of the strip 2506 should not extend all the way to the free end or tip 2501 of the panel 2502. There may be a gap provided or the strip 2506 may become thinner toward the free end or tip 2501 of the panel 2502. The strips 2506 provide structure to the panel 2502 membrane to maintain shape. Narrowing the strip 2506 toward the tip 2501 of the panel 2502 may keep the panel's (2502) shape in moderate speeds, but may bend backward just like an umbrella turning inside out under strong wind which may act like relief valve. The fins 2505 will restrict opening of the flaps 2500 to 180 degrees. Because there is no sudden direction change, the flaps 2500 may operate more quietly.

During operation of the check-valve turbine, extremely high wind speeds, for example, or sudden gusts of wind, may pose a danger to the operation of the turbine. The force of the wind on the sail, combined with the inertia of the system, could be strong enough to damage or destroy the sails, for example, or the entire turbine system. To prevent this from happening, some or all of the flaps in a check-valve turbine may be constructed with relief mechanisms that open in response to a predetermined load to reduce the force on the system and prevent damage or destruction. The flaps, being smaller than the whole sail itself, carry a smaller inertia, thereby enabling the flaps to react quicker to sudden changes in load than would the entire sail.

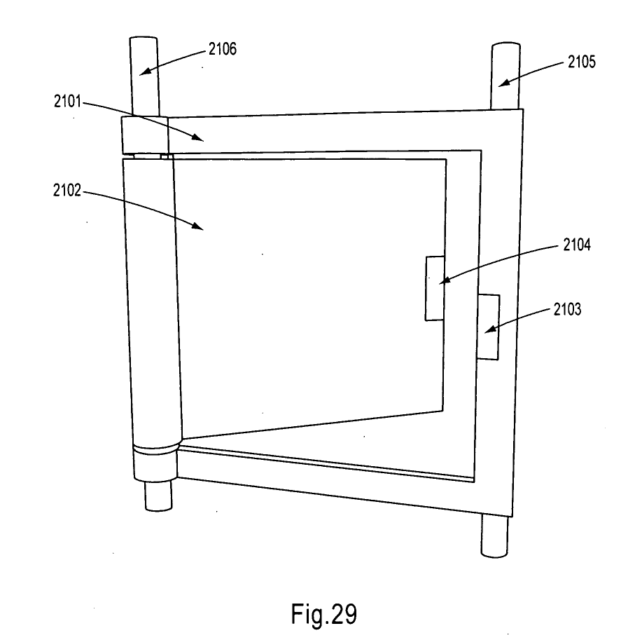

FIG. 29 shows an embodiment of a relief mechanism having a relief flap 2100 that comprises a U-shaped primary flap member 2101 and a rectangular secondary flap member 2102, for example. The independent flap members 2101 and 2102 rotate around the same axis, which may be a horizontal or vertical lattice member, for example. A ferrous metal strip 2103 may be attached on an inner perimeter surface of the outer flap member 2101 and a magnetic strip 2104 may be attached on a distal end of the inner flap member 2102, as shown in FIG. 29. Although described in this manner, the magnetic strip 2104 may be attached to an inner perimeter surface of the outer flap member 2101 and the ferrous metal strip 2104 may be attached to the distal end of the inner flap member 2102, or along any outer perimeter surface of the inner flap member 2102, for example. The metal strip 2103 and the magnetic strip 2104 may be designed to be attached to, or embedded in, the flap members and dimensioned to function as described herein without adding significant weight to the check-valve turbine.

The ferrous metal strip 2103 and the magnetic strip 2104 are situated to adjacently align when the inner flap member 2102 swings through the outer flap member 2101. Under normal operating conditions, planar alignment of the outer and inner flap members, 2101 and 2102, respectively, is maintained due to magnetic attraction between the ferrous metal strip 2103 and the magnetic strip 2104, which ensures that the relief flap 2100 acts as a single relief mechanism or unit. However, when the wind speed increases to a predetermined level, the forces acting on the inner flap member 2102 will break the magnetic connection between the strips 2103 and 2104 to allow the inner flap member 2102 to swing open and away from the outer flap member 2101. The sail should be designed so that the supporting mesh does not interfere with the opening motion of the inner flap member 2102. The inner flap member 2102 swings open freely to substantially relieve the forces from the wind on the combined relief flap 2100. A small gap may exist between the inner perimeter of the U-shaped outer flap member 2101 and the outer perimeter of the inner flap member 2102 to reduce any noise resulting from the engagement and disengagement of the relief valve.

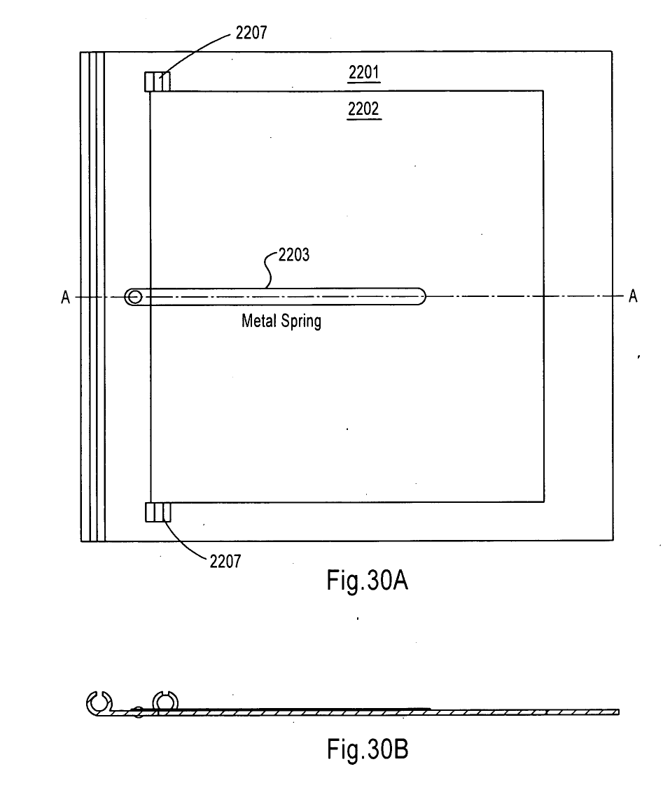

FIGS. 30A and 30B show a relief flap 2200 according to another embodiment and having an outer flap member 2201 and an inner flap member 2202. The outer flap member 2201 may have an axis of rotation about a horizontal or vertical lattice member, for example. The inner flap member 2202 has a rotation axis that is parallel to, but not the same as, the rotation axis of the outer flap member 2201. For example, as shown in FIG. 30A, hinge joints 2207 may be provided between the inner and outer flap members, 2202 and 2201, to allow the inner flap member 2202 to swing between open and closed positions. A strip spring 2203 is joined to the outer flap member 2201 and pushes the inner flap member 2202 to be in a closed position. When the wind speed reaches a predetermined level, the strip spring 2203 allows the inner flap member 2202 to open. When the increased load on the relief flap 2200 subsides, the strip spring 2203 pushes the inner flap member 2202 back to a closed position. The strip spring 2203 may be designed of lightweight metal, such as aluminum, for example, or may be composed of any suitable material that is lightweight and can be manufactured with the correct stiffness. FIG. 30B shows the cross-sectional view of the relief flap 2200 shown in 29A as taken along A-A.

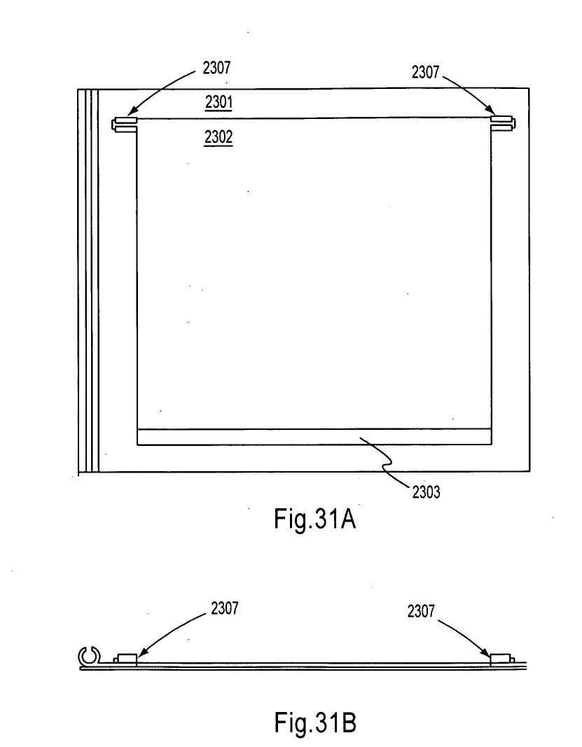

FIGS. 31A and 31B illustrate a relief flap 2300 according to yet another embodiment and having an outer flap member 2301 and an inner flap member 2302. The outer flap member 2301 may have an axis of rotation about a horizontal or vertical lattice member, for example. The inner flap member 2302 has a horizontal rotation axis that is not shared with the rotation axis of the outer flap member 2301. For example, as shown in FIG. 31A, hinge joints 2307, for example, may be provided between the inner and outer flap members, 2302 and 2301, to allow the inner flap member 2302 to swing between open and closed positions. A weighting device 2303, such as a metal strip, may be joined to the bottom of the inner flap member 2302. The weighting device 2303 relies on gravity to maintain the inner flap member 2302 in a closed position. The weight of the weighting device 2303 may be such that when the wind reaches a predetermined speed, the forces acting on the inner flap member 2302 cause the inner flap member 2302 to lift and allow wind to pass between the outer flap member 2301 and the inner flap member 2303.

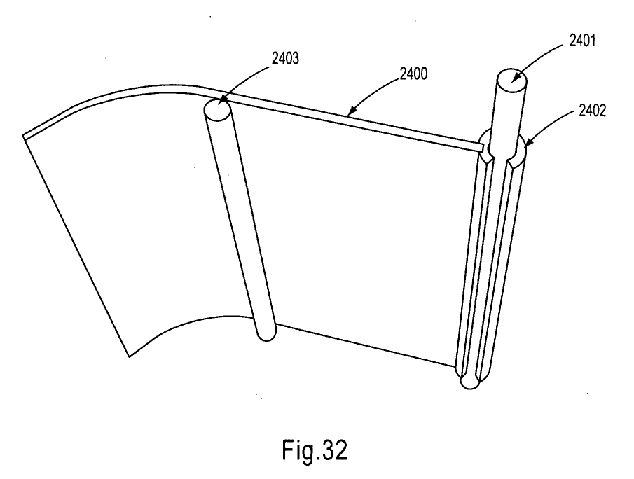

FIG. 32 shows a relief flap 2400 according to another embodiment and which is comprised of elastic material. The material keeps its initial shape in mild to moderate wind speeds and bends backward when the wind speed reaches a predetermined level. The bending allows some of the air to escape to relieve stress from the sail. As shown in FIG. 32, while the relief flap 2400 rotates around grid wire 2401, the wire 2403 restricts the rotation of the flap and keeps it in a closed position. Under normal loading conditions, the relief flap 2400 is straight. The wire 2403 may be adjusted to be of varying distance from the grid wire 2401. If the wire 2403 is closer to grid wire 2401, the relief flap 2400 bends more under moderate wind speeds. Based on the elasticity of the material of the relief flap 2400, the location of the wire 2403 is determined to enable sufficient bending at the predetermined wind speed so that air may escape and relieve pressure on the sail.

A marine check-valve turbine, for example, may have rectangular, flat sails which include, for example, grid-structured, rectangular, flat sub-sails on which flaps are attached. The sail, sub-sail and flap, each have rotation capabilities. While the sail and sub-sails have a 360 degree rotation capability, the flaps have a maximum 180 degree rotation flexibility. The reason(s) for the flexibility in rotation is(are) described in further detail herein.

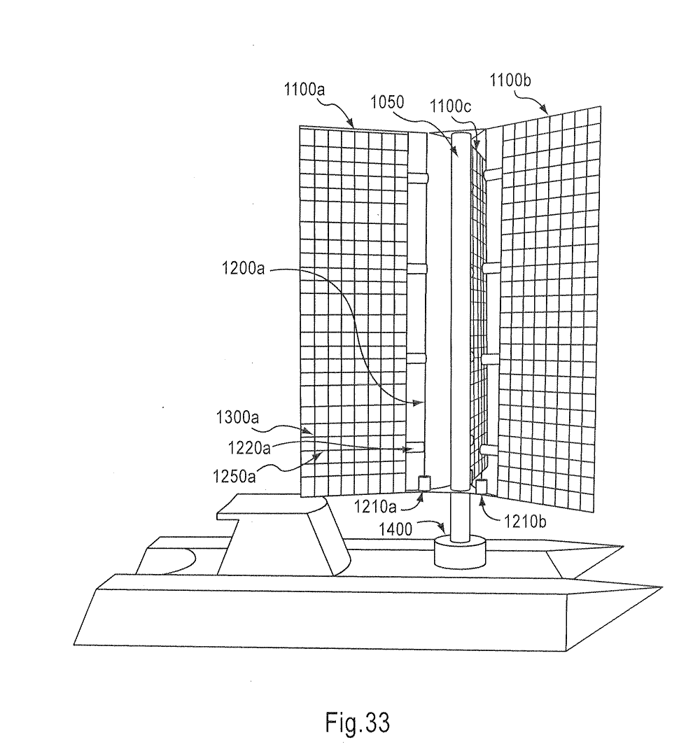

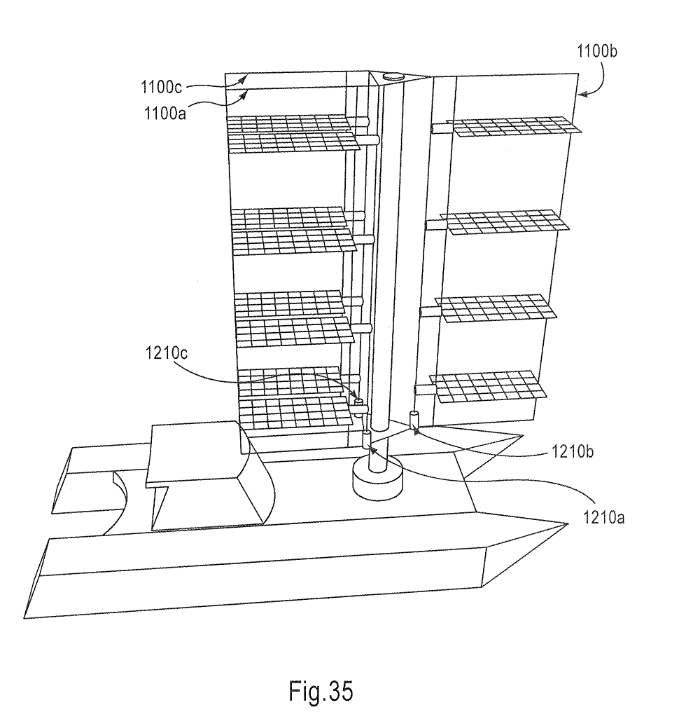

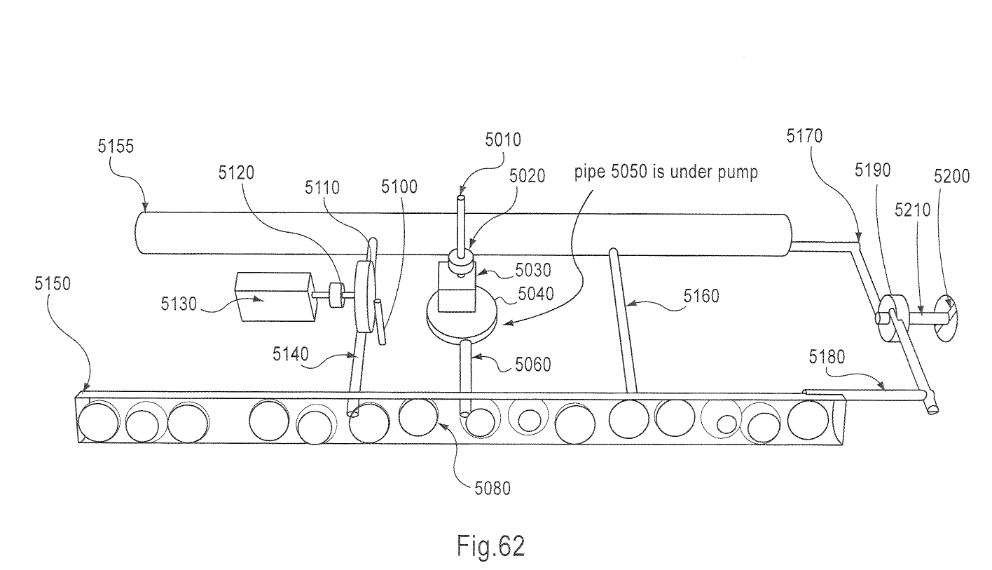

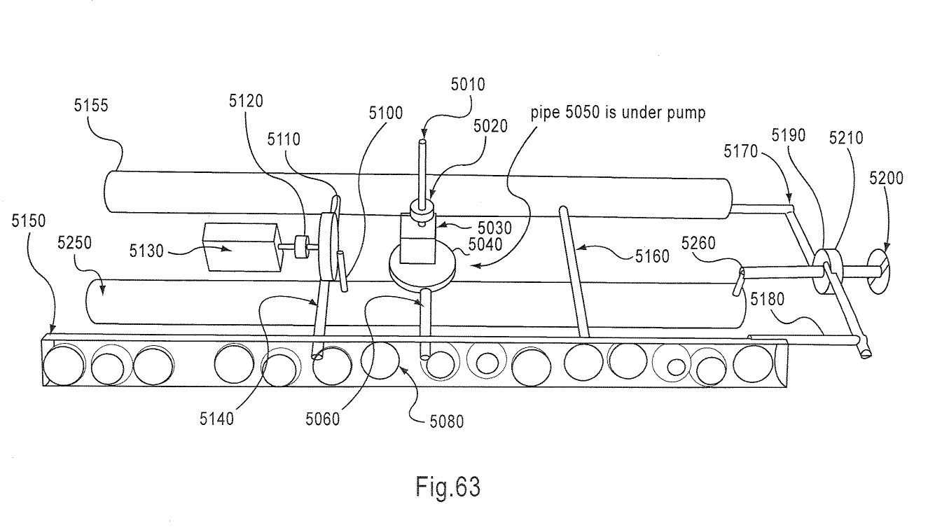

FIG. 33 shows a marine check-valve turbine applied to a catamaran-type sailboat, for example. It should be noted that a wind is blowing from the direction of the observer (starboard direction of the boat) in FIG. 33. Accordingly, sail 1100a has a positive face and sail 1100b has a negative face facing toward the observer. As such, the flaps 1300a on the sail 1100a are in a closed position while the flaps 1300b on the sail 1100b are in an open position (mostly hidden by a grid structure of the sail). A motor 1210a may be used to rotate a hinge beam 1200a to change the configuration of the sail 1100a. Similarly, motors 1210b, 1210c (FIG. 35) may be used to rotate the hinge beams 1200b, 1200c to change the configuration of the sails 1100b, 1100c. As shown in FIG. 33, each sail 1100a, 1100b, and 1100c has at least one sub-sail 1250a, 1250b, and 1250c, respectively. A sub-sail motor 1220a, 1220b, and 1220c may be used to rotate the sub-sail 1250a, 1250b, and 1250c. When the sub-sail 1250a is in a closed position, it may be hard to distinguish the sub-sail 1250a from the sail 1100a. A rotation platform 1400 is built like a caterpillar machine rotation platform. A main beam 1050 is attached to the rotation platform 1400. When the sails 1100a-c force a rotation of the main beam 1050, the rotation platform 1400 transfers the rotation force of the main beam 1050 to a generator or any other power generating component (not shown) below deck, such as a water pump for charging an accumulator as described herein in accordance with aspects of the present invention (see e.g., FIGS. 62-63).

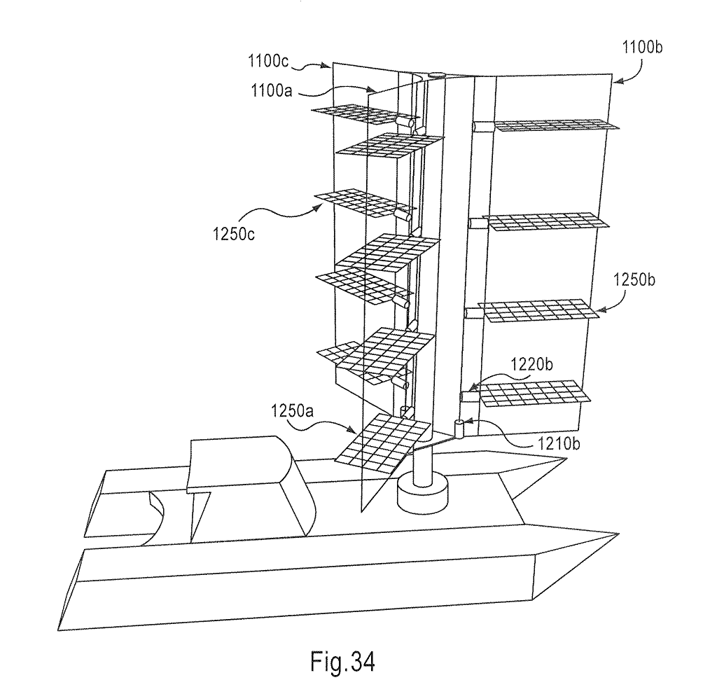

FIG. 34 shows the same boat where the marine check valve turbine is in a very windy environment where closed sub-sails 1250a-c could cause damage to the turbine. To prevent damage to the turbine, the sub-sails 1250a-c may be rotated 90 degrees, for example, by using the motors 1220a-c so that the drag on the turbine may be reduced to zero or near zero. It should be mentioned that the sub-sails 1250a-c positive faces are directed upward or skyward so that the flaps 1300a-c are in the closed position due to gravity, since downward hanging flaps 1300a-c would generate a lot of noise due to random flapping and be more susceptible to damage.

FIG. 35 shows the same boat where the sails 1100a and 1100c, for example, may be in a folded condition by using the motors 1210a and 1210c. The folding of the sails 1100a and 1100c may be necessary only in extreme weather conditions or, for example, if the boat is in a harbor and may not be used for an extended period of time. But even when the boat is in the harbor, the boat could be used to generate power for storage or to sell to utility companies, in which it may not be necessary or desired to fold the sails 1100a and 1100c.

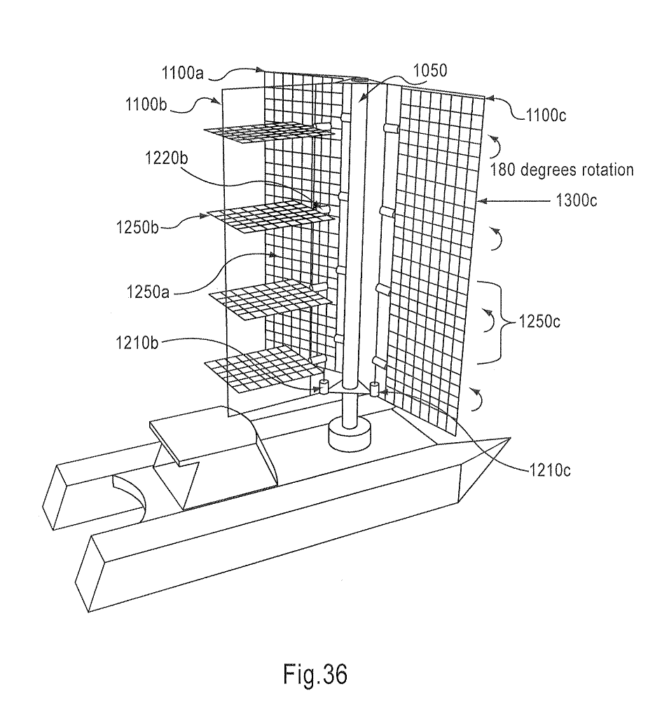

FIG. 36 shows the same boat converted for sailing by rearrangement of the sails 1100a-c and sub-sails 1250a-c. In FIG. 36, the wind is blowing from behind (stern direction) the boat and the wind power is converted to pushing the boat, rather than the wind power being used solely for generating power through use of the check valve turbine. In this configuration, for example, the sail 1100a and the sub-sail 1250a are positioned with the positive face of the sail 1100a facing the wind. The sail 1100b and the sub-sail 1250b are rotated 90 degrees by using the motor 1220b such that the positive face of the sub-sail 1250b is facing skyward. Accordingly, the sail 1100b exposes almost zero area to the wind and does not block the wind from acting on the other sails. Note that negative face of the sail 1100c would normally be facing the wind with the flaps 1300c in the open position. However, as shown in FIG. 36, the flaps 1300c are in the closed position. The sub-sail 1250c on the sail 1100c may be rotated 180 degrees by the motor 1220c in order to show a positive face to the wind. FIG. 36 also shows that the sails 1100a-c may be positioned so as not to be equally circumferentially spaced. Instead of having 120 degree angles between the sails 1100a-c, there is shown a 60 degree angle between the sails 1100b and 1100a. The rotational configuration of the sails 1100a-c may be accomplished by the motors 1210a-c (see also FIG. 35), for example, rotating the sails 1100a-c to a predetermined position. Once each sail 1100a, 1100b and 1100c are locked in individually determined circumferential positions, by slightly rotating the main beam 1050 clock-wise or counter-clock-wise using a motor (not shown) provided below deck, the boat can be navigated as long as wind is favorable to navigation in this manner. Upon a change in direction of the wind so that it is no longer favorable to use the sails 1100a-c for pushing the boat, the sails 1100a-c can be reverted to being used as a check valve turbine to power and/or propel the boat by generating electricity or any other power conversion means.

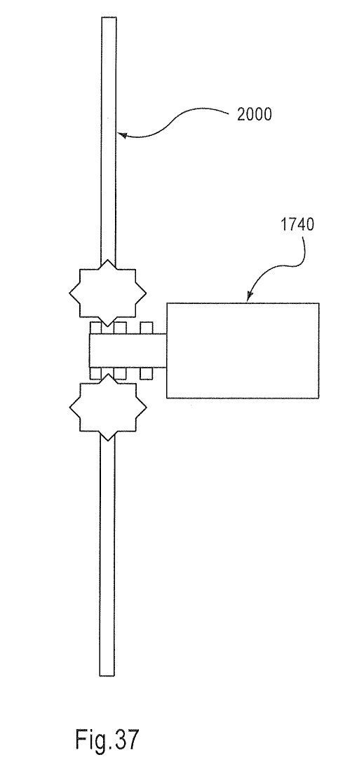

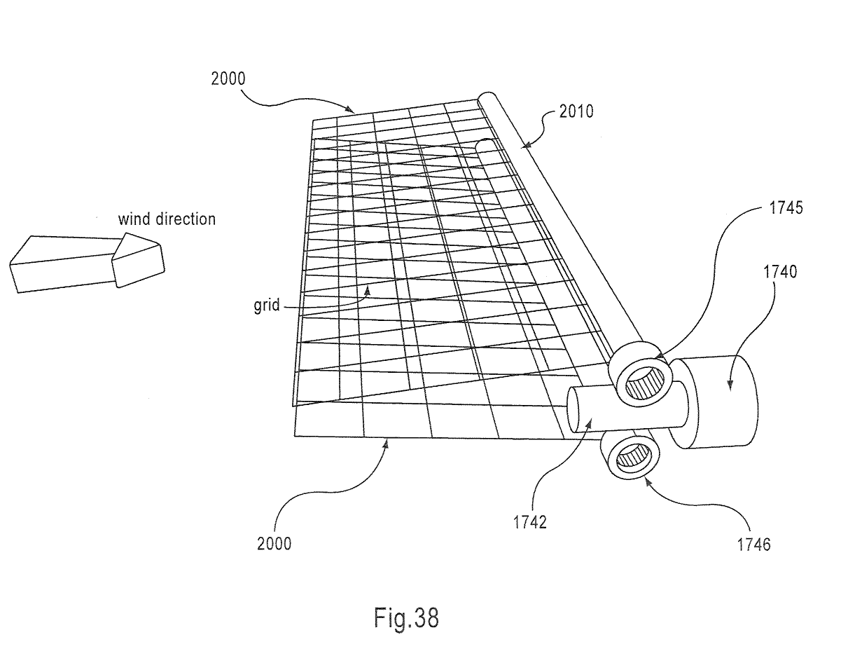

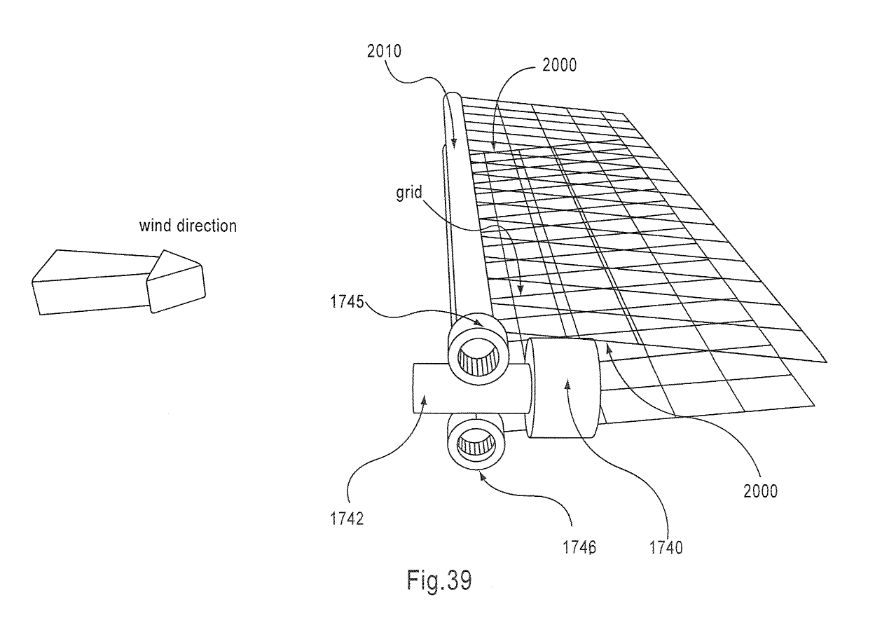

FIG. 37 illustrates a schematic diagram of a rack and pinion control system that is configured to control at least the rotation of a sub-sail 2000 through 90 degrees. The push and pull operation of the rack and pinion control system may be powered by an electric motor or a pneumatic system, such as an air cylinder 1740. FIG. 38 shows the sub-sails 2000 folded toward the positive face and FIG. 39 shows the sub-sails 2000 folded toward the negative face.

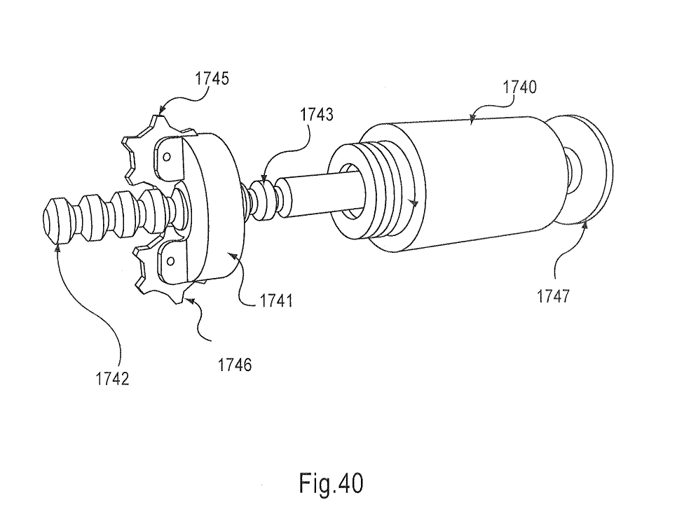

The rack and pinion control system requires a linear push-pull motion to move the sub-sails 2000. The linear push-pull motion is accomplished by converting a rotational motion of an electric motor or a hydraulic motor to linear motion, or an air cylinder, for example, may be used to provide a mechanism for the push-pull operation. As shown in FIG. 40, a shaft of a pneumatic air cylinder 1740 may be used as a rack shaft 1742. FIG. 40 shows the inner details of the air cylinder 1740. A front lid 1741 of the air cylinder 1740 should be configured to be wide enough in an axial direction of the rack shaft 1742 to allow at least two tips 1743 of the rack shaft 1742 to rotate within the air cylinder 1740 without the seal of the front lid 1741 allowing any air to escape from the air cylinder 1740. A rear lid 1747 is configured to seal the air cylinder 1740 at an opposite axial end of the air cylinder 1740. Air is prevented from escaping from the air cylinder 1740 while the rack shaft 1742 is used to power pinion gears 1745, 1746 on the sub-sail 2000. The rack shaft 1742 may be configured to extend from both ends of the air cylinder 1740. To ensure a proper seal at the point where the tips 1743 of the rack shaft 1742 enter the air cylinder 1740, grooves 1744 on the rack shaft 1742 should be formed thereon so that when the pinions 1745, 1746 engage the rack shaft 1742, the tips 1743 of the rack shaft 1742 are not damaged.

The air cylinder 1740 may be configured to be pressurized and depressurized to force a piston movement of the rack shaft 1742, for example. An annular piston ring (not shown) may be provided on the rack shaft 1742 at a point interior to the air cylinder 1740 so as to seal off a chamber in the air cylinder that may be pressurized or depressurized to force movement of the piston ring and corresponding movement of the rack shaft 1742. The piston ring may separate the interior of the air cylinder 1740 into multiple chambers, in which chambers on both sides of the piston ring, for example, could be air operated to force movement of the rack shaft 1742. Additionally, the chamber in one end may be pressure controlled and a spring may be provided at the other end of the air cylinder for back and forth linear movement of the piston ring and the rack shaft 1742. The rack shaft 1742 may be configured with a square cross-dimensional shape, or any suitable shape, to prevent the shaft 1742 from rotating, for example, during linear motion.

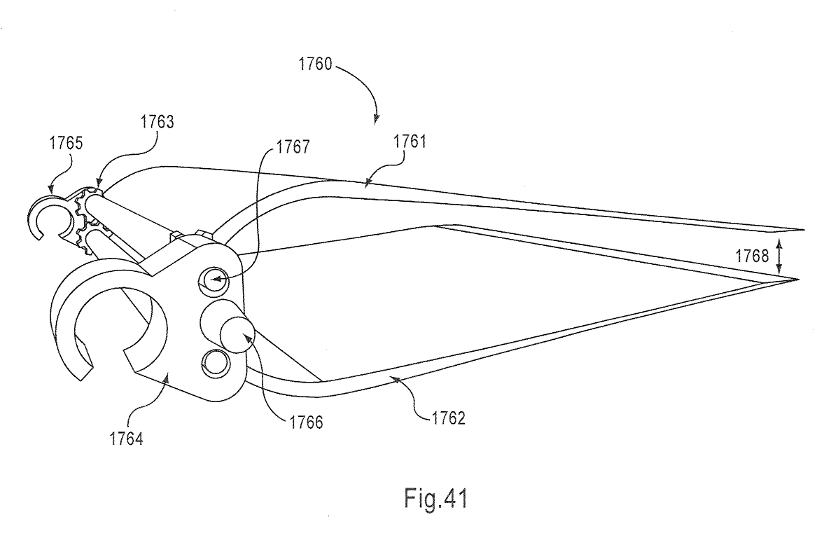

A similar two gear or pinion system may also be used with two flaps 1761, 1762, for example, so that the flaps 1761, 1762 may act in tandem to give a desired check-valve action for the check-valve turbine. FIG. 41 shows such a two-leafed flap mechanism 1760 during negative motion (motion against the wind). The flaps 1761, 1762 may be attached to horizontal wires at joints 1764, 1765. A rotation restrictor 1766 may be in contact with the vertical wires to prevent the flaps 1761, 1762 from sagging downward due to a moment exerted by the weight of flaps 1761, 1762. For example, as shown in FIG. 41, gravity may act to force the flap 1762 downward, thus resulting in the flaps 1761, 1762 possibly opening while at the same time, gravity acts to force the flap 1761 downward, thus resulting in a counteractive manner, in the flaps 1761, 1762 possibly closing. The flaps 1761, 1762 are joined by gears 1763 and do not rotate independently. If one flap 1761, 1762 rotates, the other flap 1761, 1762 should rotate in the opposite direction. As such, while the lower flap 1762 attempts to open due to gravity, the top flap 1761 attempts to close due to gravity. The combined effect of the two flaps 1761, 1762 results in the flaps 1761, 1762 remaining closed during the negative motion. Also, as depicted in FIG. 41, the wind may act on the flaps 1761, 1762 in such a way that the wind tries to close the flaps 1761, 1762.

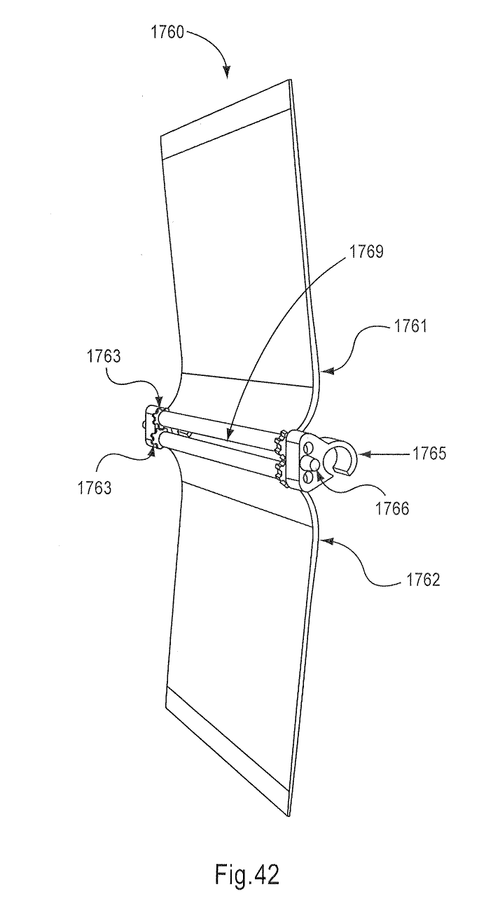

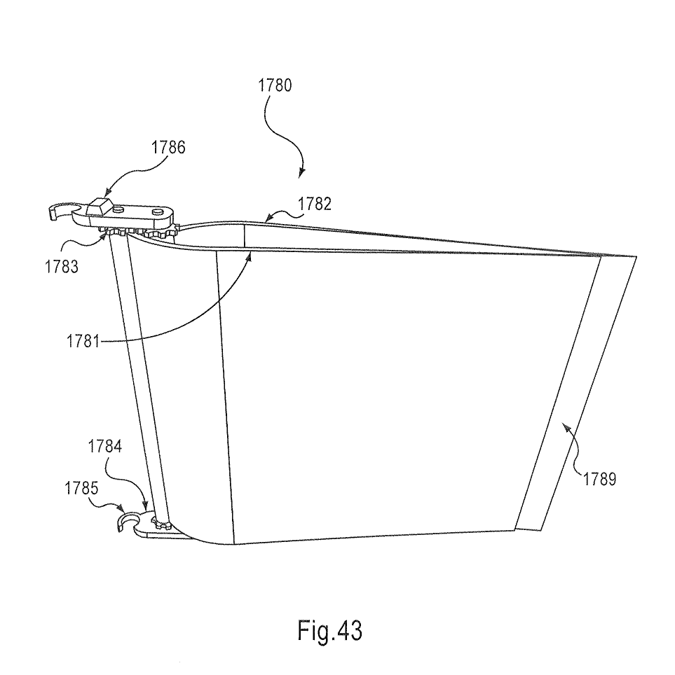

FIG. 42 shows the same two-leafed flap mechanism 1760 in the positive motion (i.e., the same direction with the wind). The wind enters a gap 1768 (see FIG. 41) between the flaps 1761, 1762 and forces the flaps 1761, 1762 to open. Because the flaps 1761, 1762 are joined by gears 1763, the flaps 1761, 1762 will open together. The opening and closing of the flaps 1761, 1762 is accomplished via the wind. To reduce possible noise generated at the end of the opening and the closing motions of the flaps 1761, 1762, soft rubber-like material, for example, may be attached at appropriate places on each flap 1761, 1762 to reduce or absorb sudden impacts. FIG. 42 shows the joints 1764, 1765 of the two-leaf flap mechanism 1760 may be a snap-ring type design. An air gap 1769, as shown in FIG. 42 between the rotation axes of the two flaps 1761, 1762, should be configured so that the gap 1769 is as small as possible. The sides of the flaps 1761, 1762 are shown as open in FIG. 43, however the sides could be closed, or raised, to create scoop like flaps similar to those shown in FIGS. 17C and 17D.

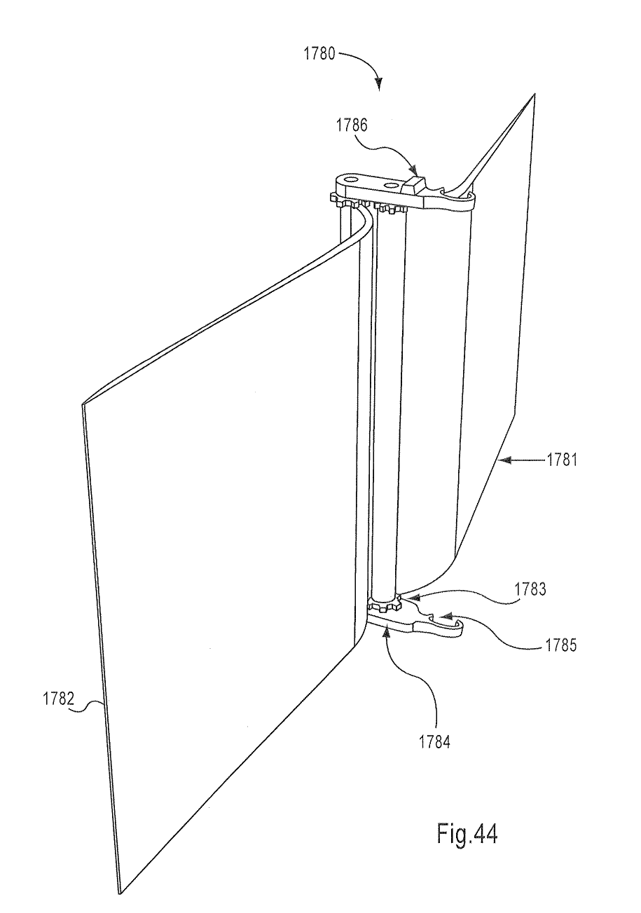

The rotation axes of the flaps 1761, 1762 in FIGS. 41 and 42 were horizontal and the flaps 1761, 1762 configured to be attached side-by-side. The side-by-side configuration may create increased drag during the negative motion of the flaps 1761, 1762. To prevent or decrease the drag effect, as shown in FIG. 43, one flap 1781, 1782 of the two-leafed flap mechanism 1780 may be positioned behind the other flap 1781, 1782, respectively. As such, the rotational axis of flap 1782 may be hidden behind the rotational axis of flap 1781 to minimize the area exposed to the wind during the negative motion of the flaps 1781, 1782. The flaps 1781, 1782 may attach to the vertical wire (not shown) through joints 1785 while permitting a rotation restrictor 1786 to contact the horizontal wires, in order to prevent a support arm 1784 from continued rotation. Thus, the inventive marine check turbine behaves similar to a pull type Darrieus turbine at the transition points from the positive to the negative motion, or vice-versa. As shown in FIG. 43, a flap tail 1789 of the flap 1782 is dimensioned such that the flap 1782 extends outward relative from the support arms 1783, 1784 further than the flap 1781. Because the flap 1782 is behind the flap 1781, the flap tail 1789 of the flap 1782, by extending beyond an outermost end portion of the flap 1781, helps to open the flaps 1781, 1782 when the flaps 1781, 1782 transition from the negative motion to the positive motion. Moreover, the flaps 1781, 1782 may be constructed as scoop flaps for increased efficiency. For illustrative purposes, FIG. 44 shows a rear view of the two-leafed vertically attached flap mechanism 1780 in the positive motion where the two flaps 1781, 1782 are in an open position due to the wind.

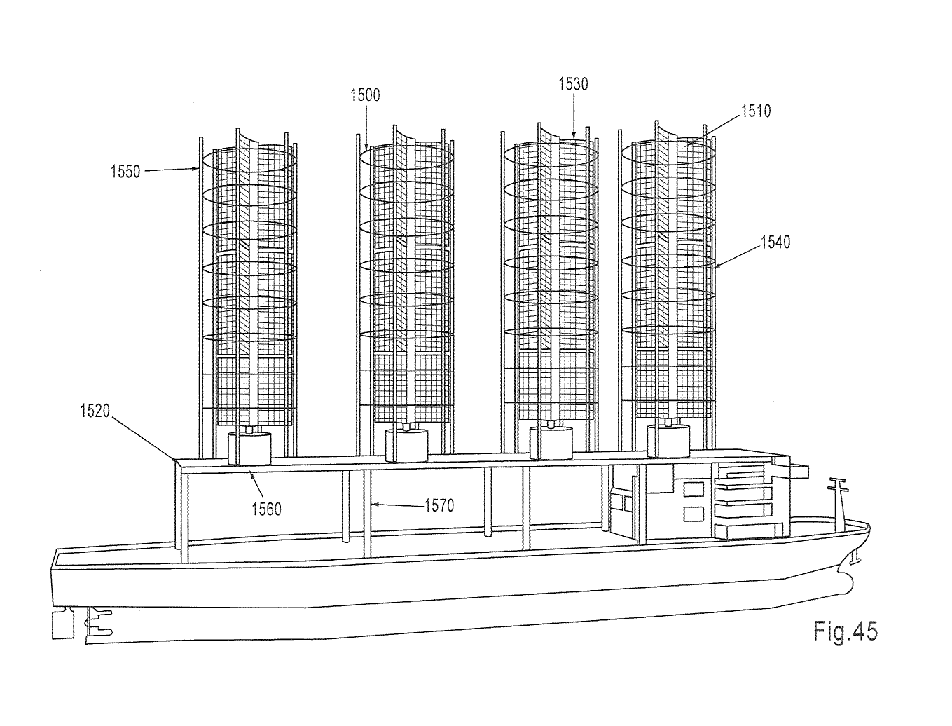

The application of a marine check-valve turbine is not limited to powering small boats. To power a smaller boat, for example, one medium sized marine check-valve turbine might be sufficient. However, a large ship, due to its enormous size, may require multiple large marine turbines. FIG. 45, for example, shows a ship powered by a version of a marine check-valve turbine. A large turbine may be configured with large sail assemblies having substantial width and height. The substantial width of a sail assembly 1530 may require a longer stem 1510 for a sub-sail 1540. An extension of the stem 1510 could cause downward sagging of the stem 1510 due to gravity and/or bending as a result of the wind pressure. Accordingly, the larger sub-sails 1540 are configured to have a supporting mechanism (not shown) at the tip of the sub-sail stems 1510. The supporting mechanism is described subsequently and interacts with supporting rings 1500 to create a solid base for the sub-sail stems 1510 and prevent the sub-sail stems 1510 from sagging or bending. In this manner, the sub-sail stems 1510 may be supported at an inner portion by the mast 1580 and at an outer portion by the supporting rings 1500 to effectively carry the weight of the larger sub-sails 1540. The supporting ring 1500 may be supported by vertical support beams 1550, for example, which may extend down to the platform 1520 supporting the turbine.

Open seas offer unlimited wind power, but harnessing this power offers challenges. Three bladed wind turbines need to anchor to the sea bed which limits their application in places far away from shores. The problem again with a three bladed wind turbine in a marine application is the nacelle at the top of the turbine creates a high center of gravity. To prevent a three bladed wind turbine from toppling over in extremely windy conditions, heavy ballast must be positioned at the bottom of the turbine tower if used in open seas. Also, the three bladed wind turbines only harness the wind power, ignoring or unable to harness the wave or tidal power at the base of the turbine.

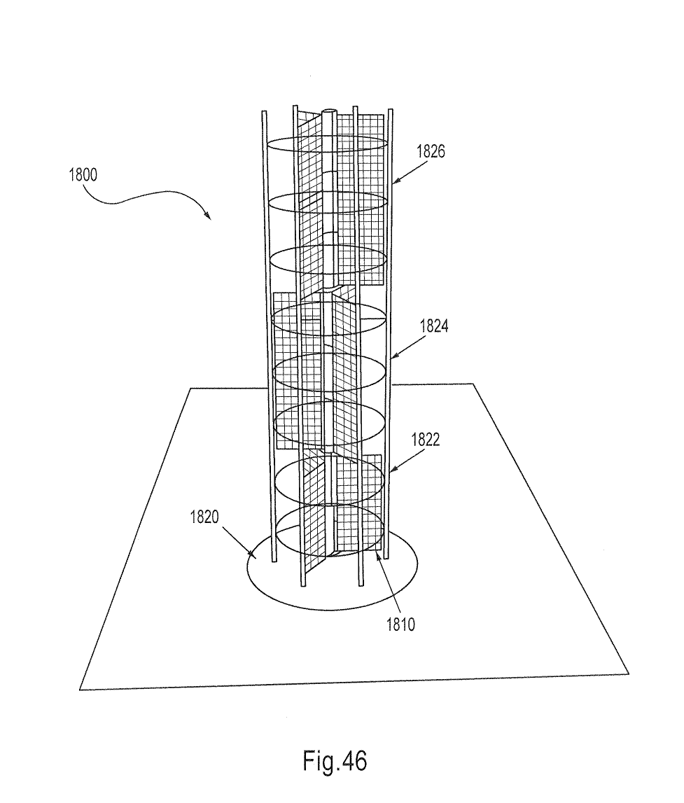

FIG. 46 shows a check-valve platform turbine 1800 mounted on a power platform 1820, which could be a free-floating sea platform, for example. The sails 1810 may be configured to approach sea level, if configured for use in a marine environment, for example. All of the heavy power producing components (not shown) may be installed below sea level inside the platform 1820. As such, the platform turbine 1800 maintains a low center of gravity, making the platform 1820 less likely to topple over in extreme wind conditions. Moreover, the first level of the sails 1822 may be configured to be close to sea level, so that wave energy may be harnessed as well by this part of the turbine 1800. Because the marine check-valve platform turbine 1800 functions omni-directionally, the turbine 1800 will function even if waves hit the first level of sails 1822 in a direction 180 degrees opposite to the wind direction. With the water being almost 875 times denser than air, the first level of sails 1822 in the turbine 1800 may contribute a larger portion of the power generated by the turbine 1800. A second level of sails 1824, and levels above same, i.e., a third level of sails 1826, may be configured to be beyond the reach of the waves and operate solely according to wind power. Furthermore, the second level of sails 1824 may be configured to have an offset with the first level of sails 1822, for example, as shown by the 60 degree offset in FIG. 46. The offset configuration may permit the turbine 1800 to rotate more efficiently, and with less turbulence, than if all of the levels of sails 1822, 1824, 1826 are aligned. An alignment of the sails 1822, 1824, 1826 shows three (3) positive faces every rotation, while offsetting the sails 1822, 1824, 1826 will show six (6) positive faces every rotation.

An advantage of a platform turbine 1800 is the ability to be left loose in the open sea to produce power or hydrogen, for example, and store the hydrogen in a submerged platform section (not shown) of the turbine 1800. Anchoring wires that would be tied to anchors on the sea floor may not be necessary for a free-floating platform turbine 1800. Furthermore, a location of the free-floating platform turbine 1800 may be monitored internally and remotely by a Global Positioning System (GPS), for example. A Voith Schneider Propeller (VSP), for example, may be provided at the bottom of the platform turbine 1800 and powered by the harnessed wind power for additional positional control of the platform turbine 1800. Since the VSP propeller is omni directional and can instantly change a direction of thrust 360 degrees, the VSP propeller may provide greater maneuverability to the platform turbine 1800. By adjusting a blade arrangement of the VSP and using an internal GPS, the platform turbine 1800 can be programmed or controlled to automatically or manually follow a route through the open sea. For example, the platform turbine 1800 may be programmed or controlled to go to a harbor to empty storage tanks filled with hydrogen, for example, and resume operation in the open sea when the storage tanks are emptied.

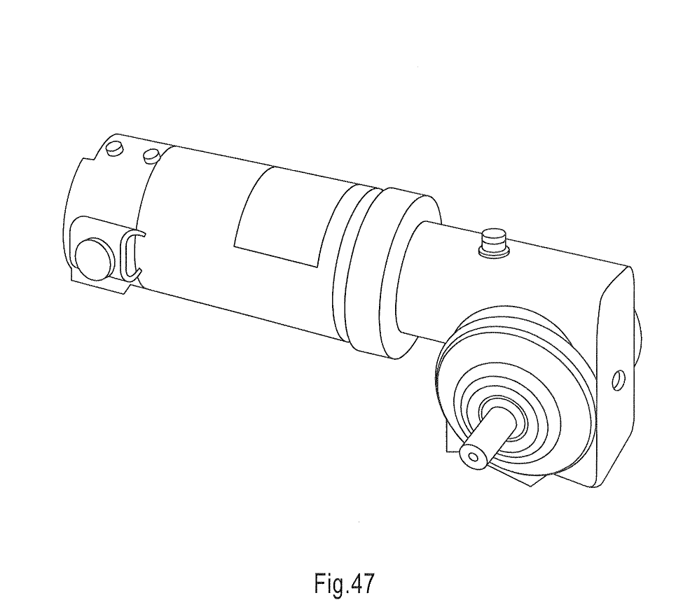

The motors as shown by 1210a and 1220a in FIG. 33, for example, which are used to rotate the sail 1100a and the sub-sail 1250a, respectively, could be electric motors or, if necessary, hydraulic or pneumatic motors as shown in FIG. 47. To use electricity, hydraulic or pneumatic motor systems require that electricity, pressurized oil or air should be produced at a rotating part of the turbine with a small unit attached to the rotating platform. Inside the platform, tubes of the system may be used to store pressurized air or as oil storage for hydraulic components. The pressurized air or oil may be controlled by a small compressor or pump (not shown) located on the rotating platform and powered by wind, similar to a bicycle generator attached to a tire, for example.

While a particular embodiment of a flap may be described above with regards to a particular frame or sail assembly structure, it is within the scope, spirit and intent of the above described invention for any of the described flaps to be interchangeably used with any of the above described frames or structures.

For the marine check-valve turbine, in particular, having flat sails is much different than any other conventional drag type turbine. For example, the Savonius turbine has curved solid surfaces for its sails. The positive and negative drags generated in the Savonius turbine are large. However, the positive face being curved inward generates slightly more drag than the outward curved negative face. The Savonius turbines are very inefficient because the difference between the positive and the negative drag is small. However, the marine check-valve turbine positive face generates almost the same positive drag as a similar sized Savonius turbine. On the other hand, the negative surface of the marine check-valve turbine generates practically zero negative drag. The increased efficiency of the marine check-valve turbine is due to the difference between the positive and negative drag being large. Moreover, an even greater efficiency may be gained, for example, by using the flexible membrane flap, as described above and shown in FIGS. 17A and 17B, or the scoop flap, as described above and shown in FIGS. 17C and 17D.

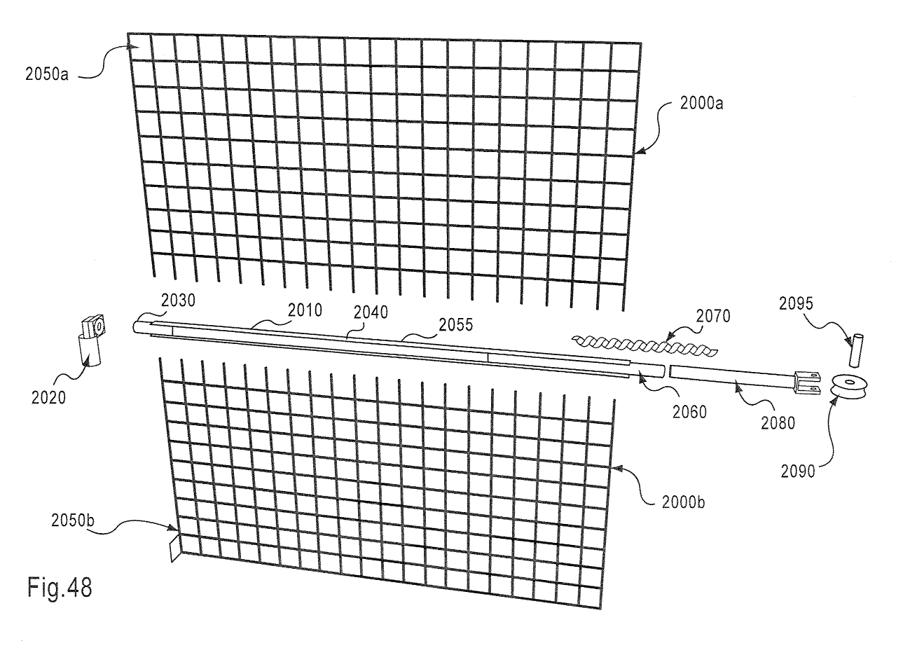

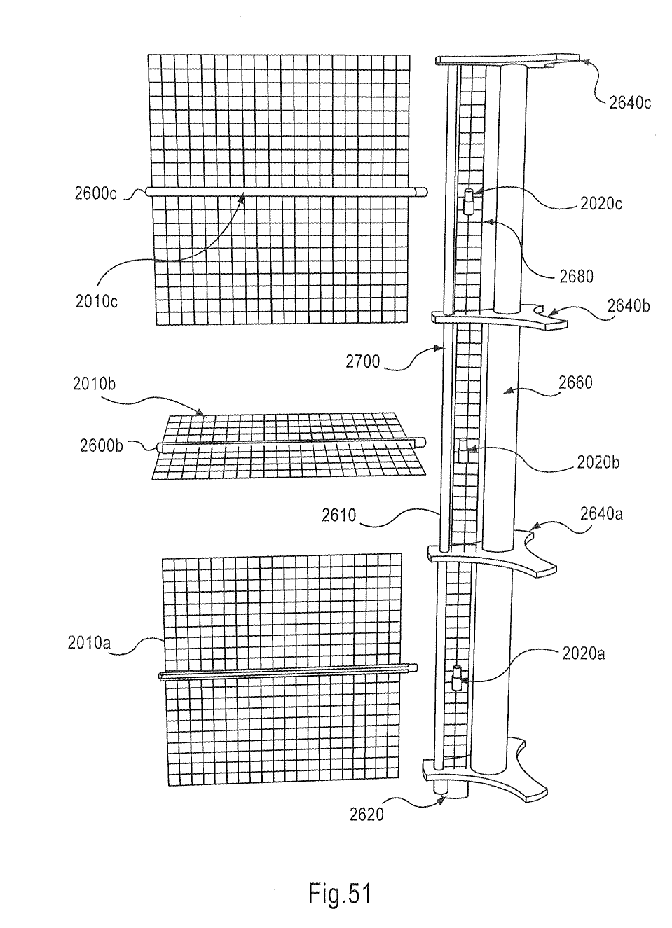

FIG. 48 shows a mechanical diagram of aspects of a sub-sail 2000 for use with a marine check-valve turbine. The sub-sail 2000 may be composed of a top grid 2000a and a bottom grid 2000b. The grids 2000a, 2000b may be comprised of any strong, rigid material, including a variety of metals or metal alloys, for example. The grids 2000a, 2000b may be welded, or joined, to a center stem beam 2010 of the sub-sail 2000. The flaps 2050 will be mounted on the grids 2000a and 2000b to rotate through 180 degrees. FIG. 48 shows a flap 2050a (upper left hand corner) in a closed position and a flap 2050b (lower left hand corner) in an open position. The flaps 2050a, 2050b will be any kind of flap described above for use in the check-valve turbine. A support cylinder 2030 will pass through a hole (not shown) on a hinge beam 2700 (see FIG. 51). The support cylinder 2030 may be connected to a motor 2020, which may be mounted on hinge beam 2070 as shown, for example, in FIG. 51 to allow the center stem beam 2010 to rotate 360 degrees.

If the size of the sub-sail 2000 is small, meaning that the sub-sail center stem beam 2010 is not extremely long, no additional support components may be necessary to be attached to the sub-sail 2000. However, where the sub-sail center stem beam 2010 is longer, i.e. for large turbines, additional support components may be attached at the outer edge of the center stem beam 2010 to prevent it from sagging. The additional support may comprise a tube 2060 attached at the tip of the stem beam 2010, as shown in FIG. 48. The tube 2060 may house a spring 2070 which will be used to push a roller arm 2080 outward, once the roller arm 2080 is positioned inside the tube 2060. A roller 2090 may be coupled to the tip of the roller arm 2080 by a pin 2095. The roller 2090 may roll, for example, on the cage ring 1500 (see FIG. 45). The spring 2070 forces the roller arm 2080 outward against the cage ring 1500 to force the roller 2090 to stay on track around the cage ring 1500. A downward sagging of the stem beam 2010 (FIG. 48) may thus be prevented by one roller 2090. Aspects of the present invention include providing a detent mechanism (not shown) in place of the spring 2070, for example, to keep the tube 2060 and the roller arm 2080 combination at a fixed length in order to prevent possible wear on the roller 2090 due to the outward force exerted by the spring 2070. However, where backward bending of the stem beam 2010 due to wind pressure on the sub-sail 2000 may cause the stem beam 2010 with one roller 2090 to dislodge from the cage ring 1500, multiple rollers 2090 may be attached to the tip of the stem beam 2010. By providing a support component at the tip of the stem beam 2010, the stability of the sub-sail 2000 is enhanced. By attaching tension wires (not shown), or a curved support beam to allow the sub-sails 2000 to rotate freely, for example, between a roller arm 2080 on one sub-sail 2000 to a roller arm 2080 on an adjacent sub-sail 2080, the rigidness of the system may be enhanced, reducing or eliminate a bending of the sub-sails 2000 due to wind pressure.

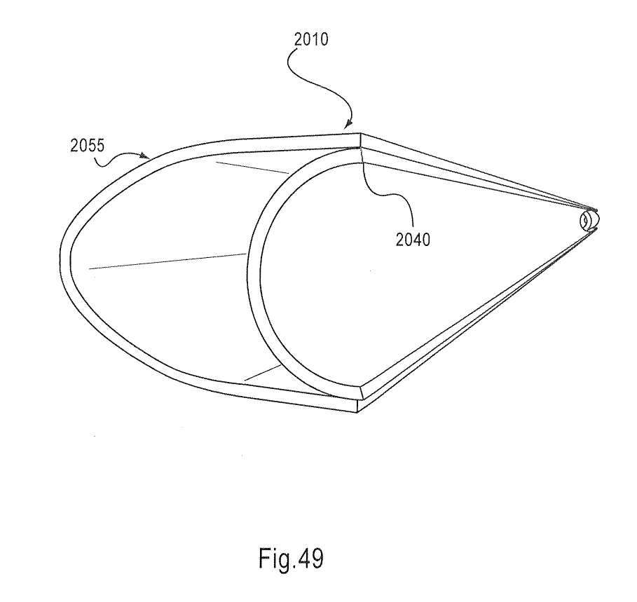

FIG. 49 shows a close up representation of a sub-sail stem beam 2010 from the positive face side of the sub-sail 2000. Note that an inward curved portion 2040 of this stem beam 2010 may resemble the curved sail of a Savonius turbine to create more drag. At the same time, the negative face side of the stem 2055 may have an airfoil shape to reduce the drag.

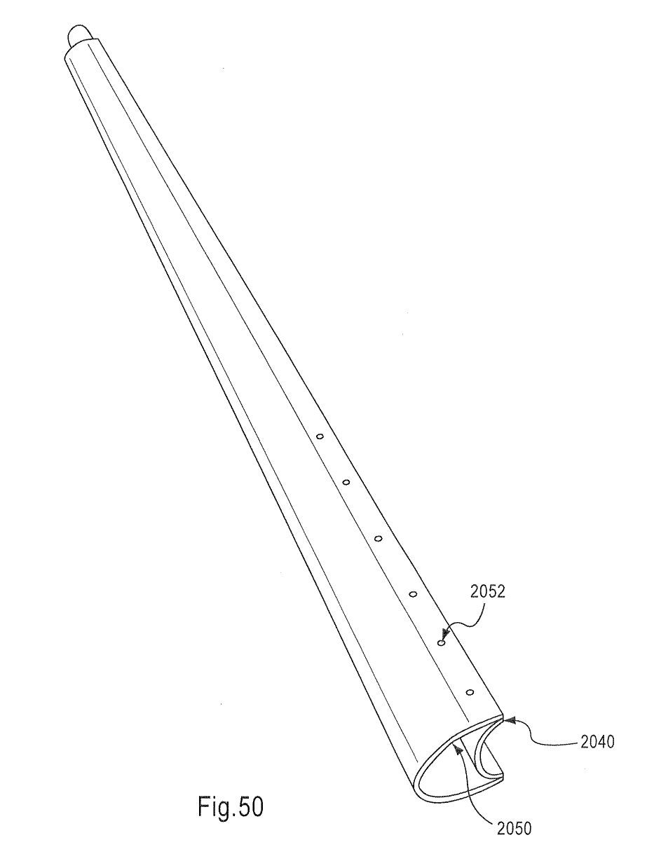

FIG. 50 shows the same stem beam 2010 from the negative face of the sub-sail 2000. Note that holes 2052 may be used to insert the metal grids 2000a, 2000b for welding onto the stem beam 2010.

The marine check-valve turbine may have two or more sails. The most efficient number of sails would be between three and five. A higher number of sails means more weight and a more expensive turbine, while a fewer number of sails may affect the turbine efficiency. By using a three sailed turbine and offsetting different levels of the sails by 60 degrees, the efficiency may be increased without an associated increase in cost. In FIG. 51, one sail 2600 of a three sailed turbine is shown. A six foot tall man is depicted to provide perspective regarding the relative size of the sail 2600. The flat sail 2600 may include three sub-sails 2600a, 2600b, 2600c. The sub-sail 2600a is shown in a normal condition with the positive face to the observer. The sail stem beam 2010a is passing through a hole on hinge beam 2700 and is joined to the motor 2020a attached to the hinge beam 2700. The motor 2020a allows the sub-sail 2600a to rotate through 360 degrees. The sub-sail 2600b is shown in storm state, for example, meaning that the sub-sail 2600b is configured to reduce a resistance to the wind. The sub-sail 2600b has been brought to the storm state position by rotating the stem beam 2010b of sub-sail 2600b 90 degrees using the motor 2020b. The top sub-sail 2600c is shown in sailing mode, for example, meaning that the sub-sail 2600c may be rotated 180 degrees by motor 2020c to allow the sub-sail 2600c to be used as a sail for propulsion. Note that sub-sails 2600a-c are shown in the three different positions for illustration purposes only. It is within the scope of the invention that the sub-sails 2600a-c on a given sail 2600 may act in tandem to operate most effectively. Fixed sails 2680 may be positioned close to the mast 2660 (center beam) and attached to the hinge beam 2610. The fixed sails 2680 rotate with the hinge beam 2610 by the aid of the hinge motor 2620. The rotation of the sail 2600 is important to allow the sail 2600 to be folded or rotated to convert from powering the turbine to propelling the boat by being used as a regular sail. The mast 2660 may rotate on a platform (not shown) which may be similar to a caterpillar-type rotation platform and allow rotation of the turbine to be passed to generators below deck. The triangle-shaped support arms 2640a, 2640b, 2640c may be used to support the hinge beam 2700 and allow the hinge beam 2700 to rotate freely. When the sail 2600 is rotating, the rotation may be passed to the mast 2660 with aid of the support arms 2640a-c. In small boat applications or smaller turbines, for example, the rotation of the mast 2660 may not be problematic. However, for larger turbines for marine or land use applications, the mast 2660 may be built as a fixed pole in accordance with aspects of the invention discussed herein.

A cage may be used for large land or marine turbines, as discussed previously and shown in FIG. 45. In order to generate large amounts of power requires large areas of the sails to be exposed to the wind, the sails of the turbine must be large. If the width of the sub-sails is small and the length of the mast is long, the turbine may be undesirably long and the main mast exposed to large bending forces. A large sail requires that the width and height of the sub-sail be proportional to each other. In certain cases, the width of the sub-sail stem beam may be long. As shown in FIG. 45, additional support may be provided for the sub-sails by a cage at the tip of the sail. The cage may include cage support beams 1550 and support rings 1500. Together, the support rings 1500 and the support beams 1550 may create a circular cage to vertically support the check-valve turbine. The support beams 1550a-f in FIG. 45 are shown extending from the horizontal support beams 1560, for example.

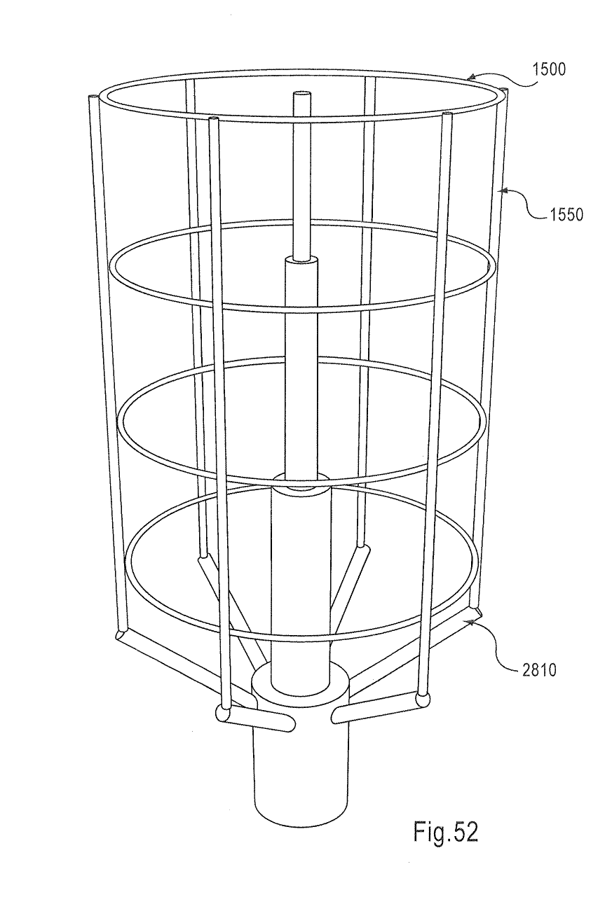

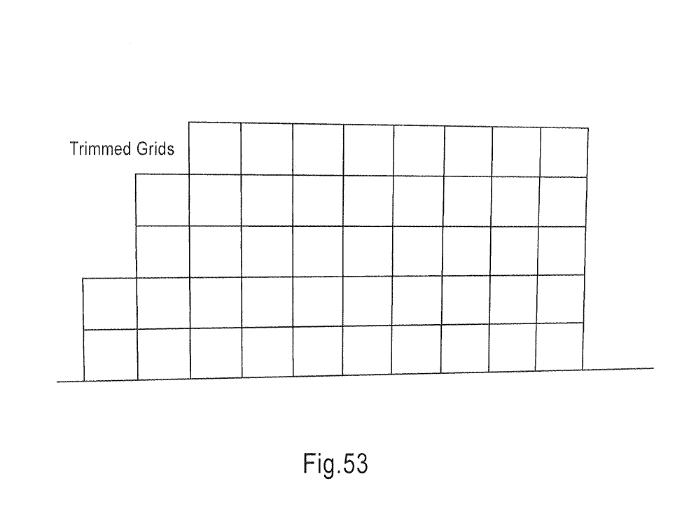

For land based turbines, to reduce a footprint of the turbine and the amount of land thus required for building the turbine, a cage may be configured as shown in FIG. 52. The bottom portion of existing three bladed turbines can be converted to support the check-valve turbine shown in FIG. 52. In this case, the blades of the HAWT will operate above the VAWT shown in FIG. 52. Support arms 2810 may support vertical support beams 1550, which may extend vertically from the arms 2810. The support rings 1500 may attach to the vertical beams 1550 to create a solid structure for supporting the sails (not shown). The cage encloses and supports the rotating sails so that in extreme conditions the turbine remains stable. A diameter of the support rings 1500 must be large enough to accommodate the rotation of the sub-sails (not shown) through 90 degrees. If the support rings 1500 are too close to the sails, it will not be possible to rotate the sub-sails 90 degrees, because the support rings 1500 will interfere with the ends of the sub-sails. To keep the sails closer to the support rings 1500, ends of the sub-sails may be configured with cut off, tapered or trimmed portions such that the ends of the sub-sails will not interact with the support rings 1500, as shown in FIG. 53.

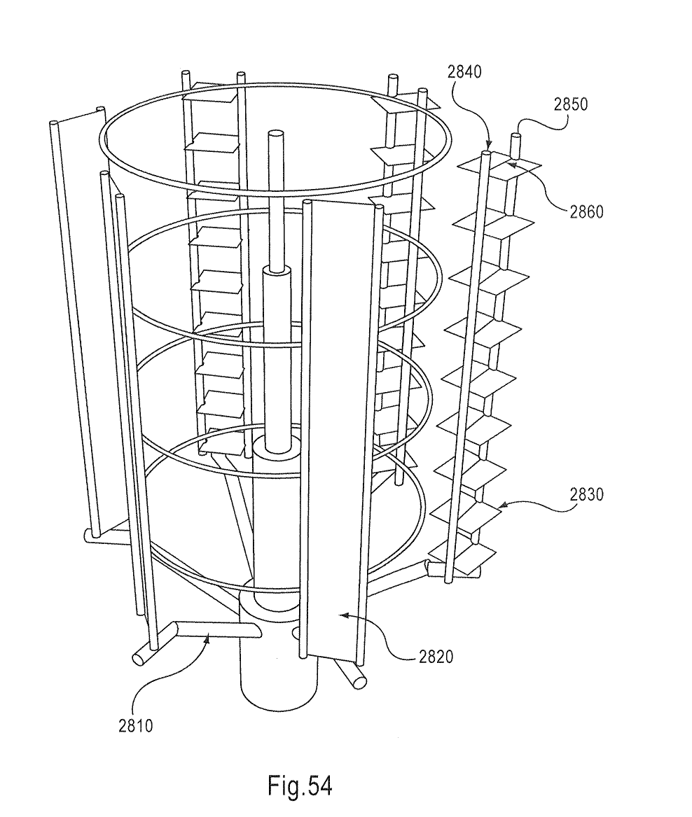

FIG. 54 shows fixed flow directing sails 2820. The fixed flow directing sails 2820 can be attached at an outer part of a cage structure 2810 for land based turbines, for example. The fixed flow directing sails 2820 may be configured to provide an optimum angle in order to direct incoming air toward a positive face of the rotating sails (not shown) internal to the cage structure 2810. The fixed flow directing sails 2820 may include sub-sails 2830, which may rotate around a center axis 2860. As shown in FIG. 54, six fixed sails 2820 are attached to the cage structure 2810, three of the fixed sails 2820 may be in a closed position at all times, while the other three fixed sails 2820 may be in an open position. The opening and closing of sub-sails 2830 may be controlled by one motor (not shown) for each fixed sail 2820. Where the configuration has six fixed sails 2820, for example, the number of motors may be six. Any time the wind changes direction, one fixed sail 2820 may close the fixed sub sails 2830 while an opposing sail 2820, for example, may open the fixed sub sails 2830. While the closed sails 2820 direct air to a positive face of the inner sails (not shown), the open fixed sails 2820 will allow air to pass freely therethrough to reduce or eliminate stress on the overall structure. The fixed sails 2820 could be used where the wind does not change direction often, so that opening and closing fixed sub sails 2830 will not consume energy. Where the wind direction is steady, for example, the gain in efficiency of the turbine may justify the cost of using the fixed sails 2820. Another advantage of using the fixed sails 2820 is that the check-valve turbine can be built first and the fixed sails 2820 can subsequently be added to the turbine.

A vertical axis wind turbine requires a heavy center beam (mast) to support the rotating sails. A prevailing concept is to use a rotating beam to support the sails, but a non-rotating center beam may also be used. The center beam is the heaviest component of a large vertical axis check-valve turbine. The biggest advantage of the check-valve turbine is that the sails used therewith may be lightweight. A rotating center beam may mean that the support system of these turbines needs to support the weight of the center beam and the sails. On the other hand, a fixed center beam means that only the weight of the sails needs to be supported. Thus for a check-valve turbine, a fixed center beam may be desirable because the sails are lightweight. Maintenance of the turbine support system may be easier in the fixed beam configuration due to a lighter load on rollers, which are easy to replace.

A rotating center beam may be used for medium sized marine turbines. The rotation platform of these turbines can be built similar to heavy construction equipment, including large winches.

While a rotating center beam may be a good configuration for medium sized turbines, where the weight of the system may not be a primary issue, large turbines may generally require that the center beam be fixed. To transport power from a fixed beam to a generator, an alternative power transmission mechanism at the base of the sails may be coupled to the generator. Mechanism power rollers may transfer power from the sails to the generator while allowing the center beam to remain fixed.

A fixed center beam requires two types of roller mechanisms to support the rotating sails. For each turbine there may be one power transmission roller and more than one (as many as the design requires) support roller. While the primary purpose of the power roller is to transmit sail rotation to a generator, it may also support the sails. On the other hand, the support rollers may be used to support the rotating sails. It is within the scope of the present invention to use any suitable configuration for the power and support rollers. To expedite an understanding of the invention, two exemplary embodiments of each roller, power and support, will be described.

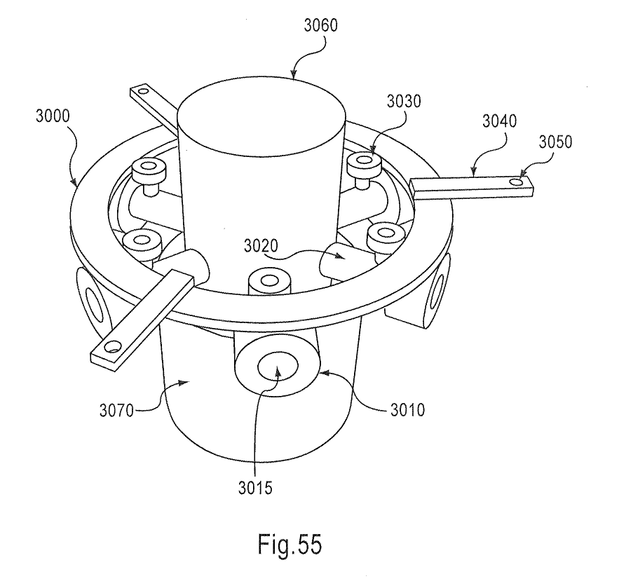

Power transmission rollers will be described with reference to FIGS. 55-57. FIG. 55 shows the details of a ring gear to roller gear power transmission mechanism. The ring gear 3000 is configured to have gear teeth provided on the lower annular surface. The ring gear 3000 engages a roller gear 3010 which supports the ring gear 3000. The roller gear 3010 may be fixed to a shaft 3015 which transmits the rotational power to a generator chamber in a turbine body. 3070. The roller gear 3010 supports the sail system and transports the power from the rotating sails to the generator (not shown). The gear ratio between the ring gear 3000 and roller gear 3010 is preferably high, so that the rotation speed is magnified and transmitted to the generator. The roller gears 3010 are relatively easy to disassemble and replace. While one roller gear 3010 is being replaced, the other roller gears 3010 continue to support the sail system. Although illustrated as a unitary component, the ring gear 3000 is not required to be configured as a single piece component, but can be configured with segmented sections so that the ring gear 3000 can be mounted around the center beam 3060 without disassembling the entire system. Rollers 3030 may be used to center the ring gear 3000, as shown in FIG. 55. The rollers 3030 can be manufactured from rubber or plastic, for example, to reduce noise. The roller gear 3010 may be configured similar to a train wheel with gears, for example. That is, the roller gear 3010 may be configured to have at least one raised side that rides along the ring gear 3000 as if riding on a track so as to center the ring gear 3000 without the need for the support rollers 3030. Arms 3040 may be used to mount the hinge beam 2700 (see FIG. 51) of a sail assembly (not shown). The hinge beam 2700 may pass through a hole 3050 defined in each arm 3040 and may be powered by a motor 1210 (see FIG. 33) which may be below the arm 3040, for example. FIG. 55 does not show the entire center beam 3060, as only a cross section of the center beam 3060 is shown to facilitate understanding of the invention.

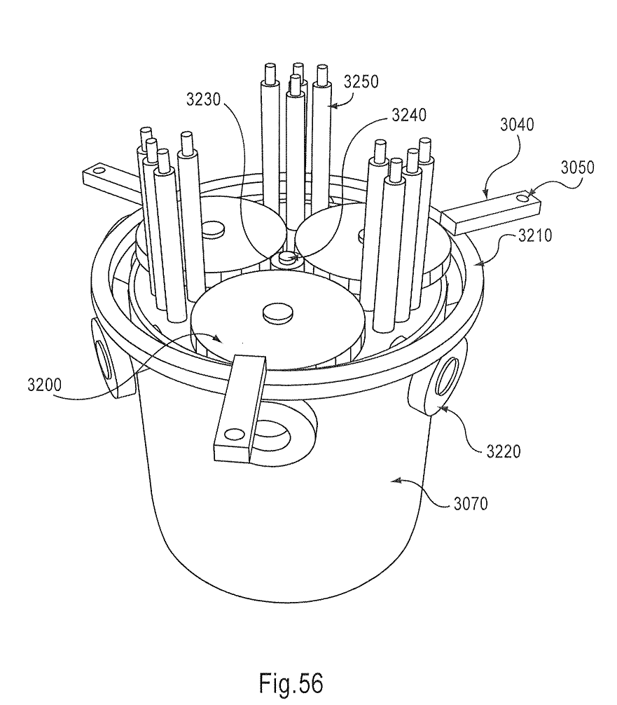

A ring gear to sun gear power transmission system, as shown in FIG. 56, uses a planetary gear mechanism to transfer the power and may also be used as a gear box to increase the rotational speed of a sail assembly that is transmitted to a generator, similar to the ring gear to roller gear power transmission mechanism discussed above. Three planetary gears 3200 may attach at the top of a power generator chamber 3070 so that the planetary gears 3200 have a fixed center. The ring gear 3210, which may be composed of segmented sections, has gear teeth (not shown) on an inside surface to engage the planetary gears 3200. The ring gear 3210 may be supported from below by rollers 3220, which are not used for power transmission. There is no need for any rollers to center the ring gear 3210, since the planetary gears 3200 automatically center the ring gear 3210. The planetary gears 3200 transfer rotational motion from the sails to a sun gear 3230 at the center of the system. A shaft 3240 attached to the sun gear 3230 will transmit the rotational energy to a power chamber 3070. The sun gear 3230 and planetary gears 3200 do not carry any load. The weight of the sails is supported by ring gear 3210 and roller gear 3220. To make room for replacement of the planetary gear 3240 during maintenance, long beams 3250 may be used to support an upper section of the mast (not shown). The beams 3250 may be located in gaps of the planetary gears 3240. Since the sails of a check-valve turbine are light, the load and stress placed on the beams 3250 is reduced.

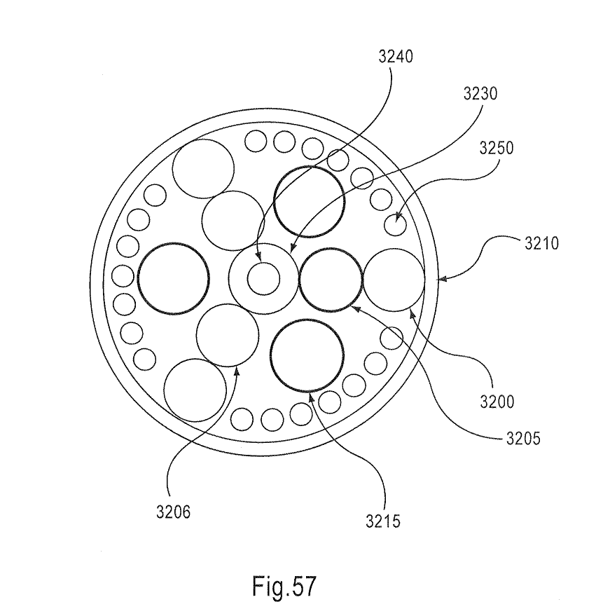

Rather than using one large planetary gear mechanism 3200 between the ring gear 3210 and the sun gear 3230, two smaller planetary gear mechanisms may be used, as shown in FIG. 57. Using smaller planetary gears may enable a more even distribution of the support beams 3050. Power is transmitted to the ring gear 3210 by the rotating sails, and the ring gear 3210 rotates the outer planetary gear 3200, which in turn rotates an inner planetary gear 3205. The inner planetary gear 3205 in turn transmits power to the sun gear 3230, wherein a shaft 3240 attached to the sun gear 3230 transfers the power to a generator. Support beams 3250 may be equally distributed along the circumference at the top of the power platform. The fixed upper portion of the turbine tower (not shown) may be bolted to the support beams 3250. Note that using two smaller planetary gear mechanisms, 3200 and 3205, allows placement of a plurality of access holes 3215 in the top of the power platform, for example. The access holes 3215 may be used by a repairman or maintenance person to access the planetary gear systems 3200, 3205 for maintenance. The diameter of the access hole 3215 should be larger than the largest planetary gear mechanism 3200, 3205, so that parts can be easily replaced. It should be noted that the bottom portion of an existing three blade turbine tower can be converted to a check-valve turbine by using a ring gear to roller gear power transmission mechanism as described herein.

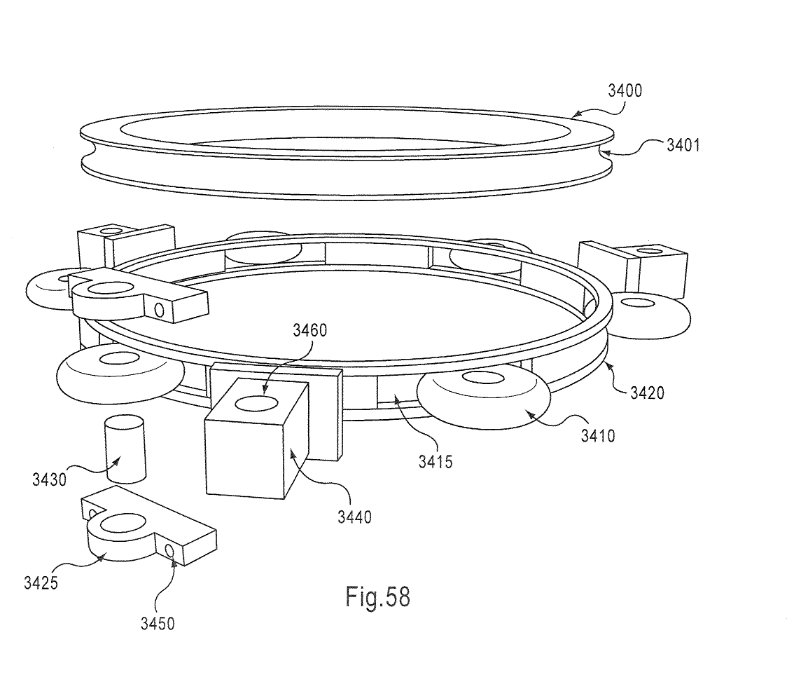

FIGS. 58-60 show various aspects of a support roller system. While one power roller may be enough to support sails of a small or medium size turbine, a large turbine may require multiple support mechanisms. Sails of large turbines may not withstand the tremendous pressure created by large sails in extreme weather conditions. The outer edges of large sail assemblies, for example, may be protected by support rings, but an inner edge of the sail assembly may require more support than is provided from a single center support. The roller system may need only one power transmission roller, but multiple support rollers may be needed.

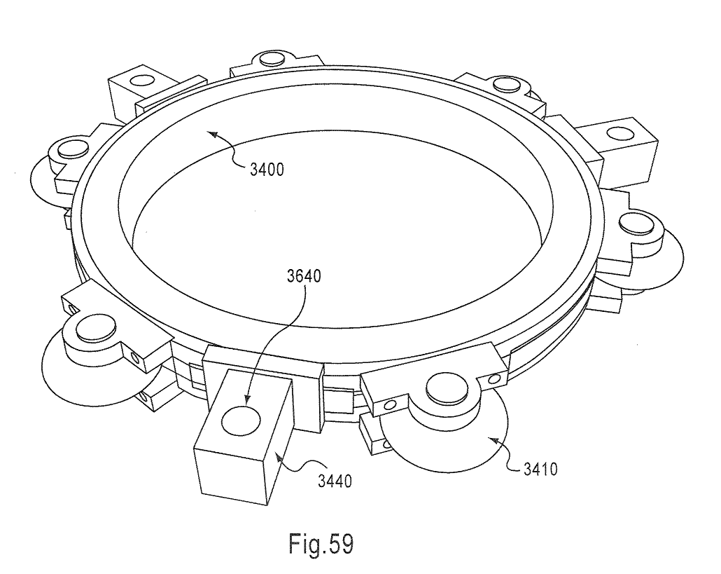

A support bearing system is shown in FIG. 58. A segmented roller bed groove ring 3400 is configured to be at the center of the bearing system. The ring 3400 may attach to a center beam (mast, not shown) of the turbine. A segmented ring 3420 with roller gaps 3415 may be formed to fit circumferentially outside of the groove ring 3400. Any circumferential gap between the two rings 3400, 3420 should be as small as practically possible. Rollers 3410 may pass through the roller gaps 3415 on the ring 3420 and may be fit to the groove 3401 in the groove ring 3400. The groove 3401 may be a half circular shape just outside of the roller 3410. The rollers 3410 will be attached to the ring gear 3420 by a support system 3425. Holes 3450 on the support system 3425 may be used to pass bolts, which may be attached to the ring gear 3420. Three sail arms 3440 may also be attached to the ring gear 3420. A hinge beam 1200 (see FIG. 33) of the sail may pass through the hole 3460 on the arm 3440. FIG. 59 shows an assembled system for the support bearing system. Since the groove ring 3400 has the deep circular groove 3401, by virtue of the rollers 3410 being held in the groove 3401, the system is mechanically solid, and the outer rollers 3410 are easy to replace, if required, due to wear.

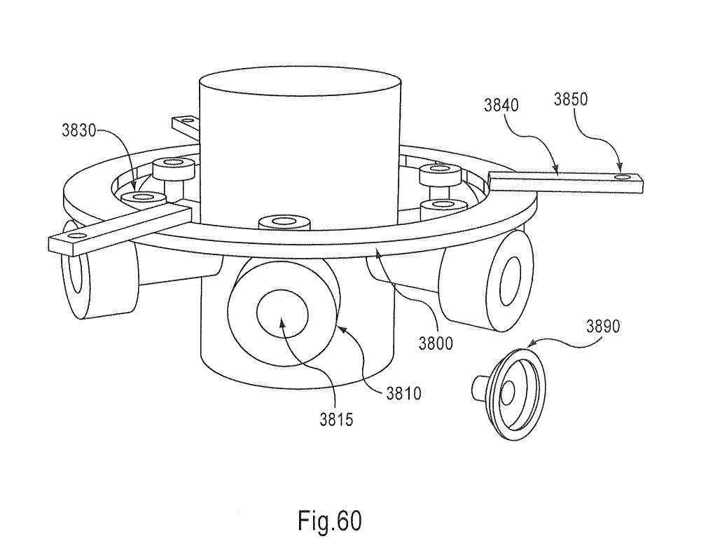

A support roller mechanism, as shown in FIG. 60, may be similar to the ring gear to roller gear power transmission system shown in FIG. 55, with the following differences. A segmented ring 3800 does not have gear teeth on the lower surface. Also, the support rollers 3810 will not have gears. The support rollers 3810 are only used to support the sail, rather than to transport power and support the sails. Since there is no power transmission by the rollers 3810, the segmented ring 3800 and rollers 3810 may be manufactured from any suitable material to reduce manufacturing cost. The remaining components in FIG. 60 are the same as shown and described with respect to FIG. 55. Centering rollers 3830 may not be necessary if train-wheel like rollers 3890, as shown in FIG. 60, are used rather than the rollers 3810.

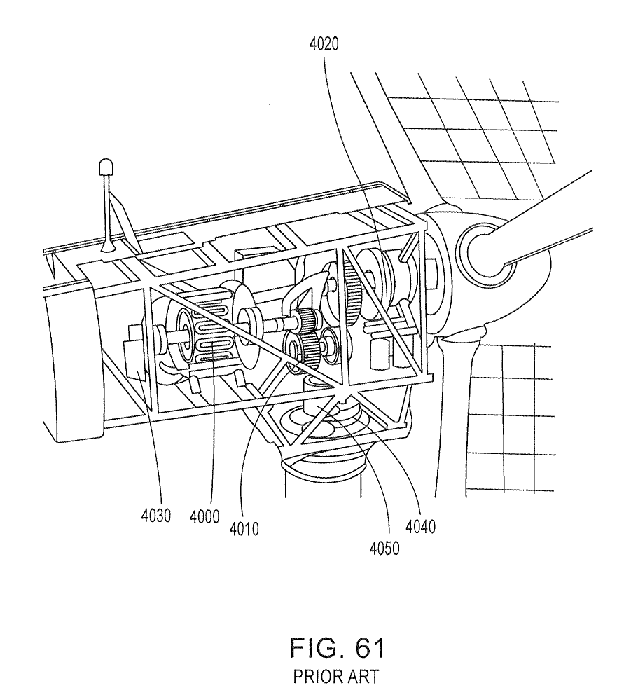

All power generation turbines, whether water, air or steam powered, have certain power components in common, such as a generator, gear box and brake system designed to respond to the restrictions imposed by the design of the system. For example, as shown in FIG. 61, three bladed turbines use a small generator 4000. FIG. 61 shows a three bladed horizontal axis turbine nacelle rotated 90 degrees so that the blades are facing upward. The size of the generator in a three bladed horizontal axis turbine is determined by the need to make the nacelle as small as possible, thus reducing resistance to the wind and making for a lighter nacelle, for example. A small generator, however, requires that the relatively slow rotation of the blades in a horizontal axis turbine must be amplified by using gearboxes in order to make power generation feasible. In marine turbine design, however, the power components may be configured to be positioned at or below ground level, which eliminates the restriction of a smaller generator for marine turbines. In marine turbines, the generator diameter can be as large as possible, thus enabling the generators to work with low RPM (revolution per minute), which, in turn, eliminates the gearbox 4010 shown in FIG. 61. Also, the power transmission component of a marine turbine, as shown in FIGS. 55 and FIG. 56, for example, may have built-in gearboxes to avoid requiring additional gearboxes. The braking system 4020 is an essential component of commercial turbines, including the inventive marine check-valve turbine(s) described herein. The braking system 4020 may be used to stop the turbine from continued rotation during maintenance or extreme weather conditions where a sub-sail, for example, may be brought to a horizontal position to protect the sub-sail from wind damage. A motor 4030 is attached to a generator shaft as indicated by the rectangular box in FIG. 61, and the motor 4030 may be used to rotate the sails clock-wise or counter-clock-wise to adjust the sails when using the sails for propulsion by wind rather than generation of power by the turbine. Slight rotations of the sails, for example, may allow the sails to extract maximum power from the wind in a propulsion mode. A gear system 4040 may be used to turn the blades toward the wind by the aid of the motor 4030 in three bladed turbines. The marine-turbine, being omni-directional, does not require the gear system 4040. Unlike the three bladed turbine blades, the marine-turbine sails and sub-sails may be individually controlled by motors. The motors require power to operate. Instead of having a complex mechanism to transfer electricity from a stationary generator to the rotating sails, a small generator and battery system may be included at the base of each sail assembly for generating enough electricity to power the sub-sail and sail motors.

A marine check-valve turbine has a distinct advantage of being used on a regular sail boat, or a wind turbine powered boat. However, any wind powered boat should have a means to power the boat during periods of extended calm when there is no wind. This may be accomplished by providing means for storing energy, such as rechargeable batteries or a power accumulation system, as described herein. However, stored energy may also not be enough to provide extended power to the boat if the calm period of the wind is longer then expected. As such, an engine may be provided as well to supply added propulsion and power to the boat, and to recharge a bank of batteries or a power accumulation system, for example, when wind power or stored energy may not suffice.

FIG. 62 illustrates a power accumulation system that may include, for example, a marine check valve turbine and/or a diesel engine, both of which may be configured to power hydraulic pumps to store energy in hydraulic accumulators. The hydraulics of this system may use sea water rather than hydraulic oil as a working medium. The system in FIG. 62 has the capability to accumulate power while using the wind turbine, the diesel engine, or both, as its power source to convert wind energy to mechanical power in a water turbine to propel the boat.

In FIG. 62, a shaft 5010 transmits rotation of a marine check-valve turbine, for example, to a gearbox 5030, which may be connected to the shaft 5010 by a coupling 5020. The increased rotation of the gearbox 5030 is transferred to a high pressure water pump 5040. An inlet 5050 (not shown) of the water pump 5040 may be extended under the boat to take in filtered sea water. The water pump 5040 forces the pressurized water to a tank 5150 through a pipe 5060. The pipe 5060 has a check-valve mechanism (not shown) which prevents pressurized water from returning back to the water pump 5040. Because water is an incompressible fluid, additional water may not be forced into the tank 5150 once the tank 5150 is full. When the tank 5150 is full, the water pressure therein is very high. Removing a small amount of water may rapidly reduce the water pressure in the tank 5150. Because a turbine 5190 relies on water pressure to operate a propeller 5200, it is important to maintain the water pressure in the tank 5150. Thus, to make it possible to pump water out of the tank 5150 without substantially reducing the water pressure, the principle of a hydraulic accumulator may be applied to the tank 5150. As shown in FIG. 62, the tank 5150 may be provided with a number of air filled compressible balls 5080. The purpose of the expandable balls 5080 is to absorb water pressure in the tank 5150 up to a predetermined pressure level. When the water pump 5040 pumps water into the tank 5150 when no extraction of water is possible, the pressure of the water will increase and the air filled compressible balls 5080 will compress by bringing their internal air pressure to equilibrium with the external water pressure inside the tank 5150. When water is released from the tank 5150, i.e., to operate the water turbine 5190, the compressible balls 5080 will expand, filling the space of the released water and maintaining a level of water pressure in the tank 5150. The number of the compressible balls 5080 may be varied and may be determined to provide an optimum number for best performance. The compressible balls 5080 may be made of rubber, or any other suitable material, to provide strength, durability and compressibility. The compressible balls 5080 are not in danger of rupturing, because, at any given moment, their internal and external pressure should be in equilibrium. And although described above with air, the compressible balls 5080 may be filled with any gas or suitable compressible material, or any combination thereof, for achieving a pressurized state in the tank 5150 through the use of the compressible balls 5080, in accordance with the invention disclosed herein.

The pressurized water may be fed to the water turbine 5190 by a pipe 5180. Another pipe 5170 may bring the pressurized water to the water turbine 5190 from another tank 5155, for example. The pressure level between the tanks 5150 and 5155 may be kept in equilibrium by a connecting pipe 5160. A rotation motion of the water turbine 5190 may be transferred to a propeller 5200 by a shaft 5210. Water may be released to the sea from the water turbine 5190 in such a manner that a jet stream of water is sent to the sea so that extra propulsion is generated during the release operation. A gear mechanism (not shown) may be used to allow rotation in a reversed direction and a differential mechanism (not shown) may be used for increased rotation speed. The system may also employ a support pump 5110, which may be powered by a diesel engine 5130, for example, for pumping water to the tank 5150 through a pipe 5140 which also has a check-valve mechanism to prevent pressurized water from returning to the support pump 5110. The inlet 5100 of the pump 5110 may be provided under the boat for the intake of filtered water from the sea. Not shown in FIG. 62 are valves for controlling the flow of water through parts of the system, e.g., for shutting off water intake or for maintenance purposes. The valves may be manual or automated. The tank 5150 may also have access holes (not shown) to allow maintenance persons to enter the tanks for repairs or replacement of parts. An air relief mechanism (not shown) may be provided on the tanks 5150 and/or 5155, for example, in order to purge any unwanted air from within the tanks 5150 and/or 5155. The tanks 5150 and/or 5155 may also be provided with a pressure regulating mechanism (not shown) to relieve extra pressure if the pressure in the tank 5150 exceeds a predetermined pressure. Furthermore, although described above with free floating compressible balls, the tanks 5150 and/or 5155 may incorporate a bladder type system (not shown), for example, attached to an interior surface of the tank 5150. A bladder type system may provide easier access for pressurization of an air chamber by an air pressure connection line in the event air escapes from the system.

The configuration of the system shown in FIG. 61 may provide for multiple tanks 5150 and 5155 to be located at each side of the boat, port and starboard, for example, to act as ballast water to provide increased stability for the boat. Moreover, when the boat is stationary, a turbine may operate to charge the tanks 5150 and/or 5155 by adding water and compressing the compressible balls 5080.

The hydraulic accumulator system may be useful for ferries, for example, where the ferry boat travels a short distance but may experience long loading and unloading times. During the loading and unloading, for example, a marine check valve turbine may charge the tanks 5150 and/or 5155. During travel, the stored power in the hydraulic accumulators could be used to augment the power generated by the wind.

If the intake of sea water is not suitable, or not desired, for the operation of the hydraulic accumulators, a third reservoir tank 5250, as shown in FIG. 63, may be used to provide a closed system. The tank 5250 should be configured to be large enough to hold enough water to fill both accumulator tanks 5150 and 5155. Exit water from the water turbine 5190 will return to the reservoir tank 5250 by a pipe 5260. Pump inlets 5050 and 5100 may be connected to the tank 5250 rather than to the sea. The biggest advantage of a closed system may be prevention of contaminated working fluid by sea-borne contaminants.

The amount of power that can be stored in the accumulator tanks 5150 and 5155 will depend on how much pressure the tanks 5150, 5155 can withstand. The higher the pressure, the more energy that can be stored. For longer traveling distances, more durable or stronger accumulator tanks 5150, 5155 should be used to allow more energy storage and less need to operate the diesel engine.

For longer voyages, the accumulator tanks 5150, 5155 may be a balance medium between the water pump 5040 and the support pump 5110. The stronger the wind is, the more the pump 5040 will be used to power the boat and accumulate the power in the tanks 5150, 5155. When the wind power reduces, the accumulated power may simultaneously augment the remaining wind power without the need to activate the engine. When the wind speed is not enough to operate the marine check valve turbine, and all of the accumulated power is exhausted, the engine may be used as the last resort.

Although the present invention has been described with reference to a number of preferred embodiments, it is to be understood that the invention is not limited to the details thereof. A number of possible modifications and substitutions will occur to those of ordinary skill in the art, and all such modifications and substitutions are intended to fall with the scope of the invention.

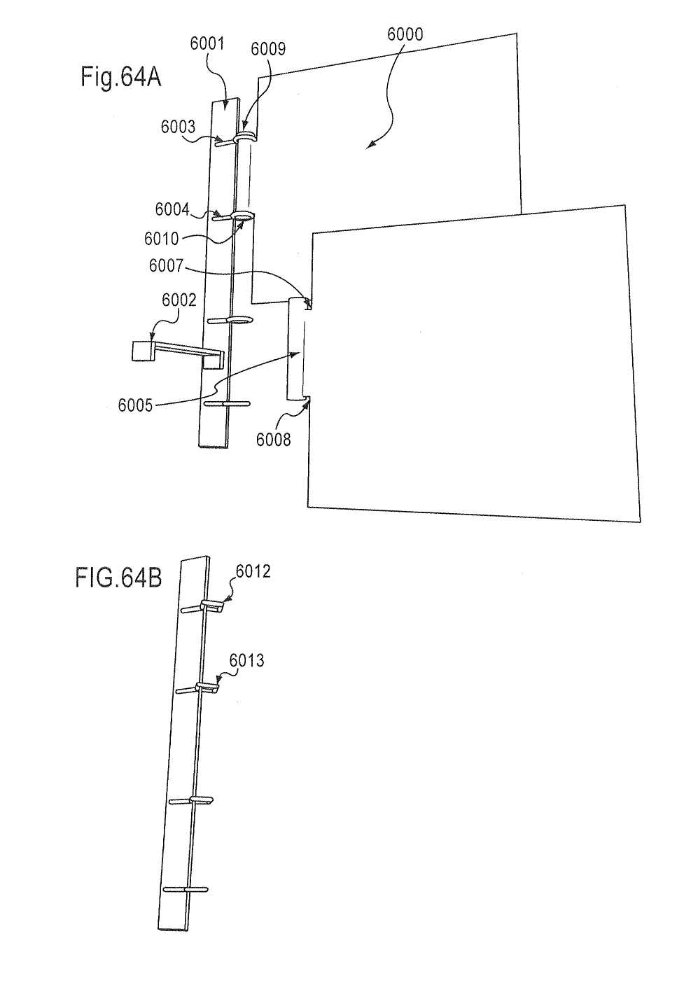

For example, although the various flaps of the present invention are shown attached to the wire grids of the sub-sail assemblies comprising round wires, FIGS. 64A and 64B show that a flap 6000 may attach to a thin metal strip 6001 by means of a round hinge top 6003 and round hinge bottom 6004. Using thin metal strips, for example, may reduce the drag profile of the grid while maintaining the strength of the grid, because the thin metal strips will show a reduced profile to the wind during a negative motion, reducing both the drag and a bending pressure. A horizontal support strip 6002 may be used to maintain a set distance between the vertical metal strips 6001 while providing additional strength to the overall sub-sail assembly. The number and location of the horizontal support strips 6002 (or vertical support strips if the flaps are attached to horizontal metal strips) may vary and should be determined according to the desired environment for the turbine assembly. As shown in FIG. 64A, the flap 6000 may be formed with or joined to a stem 6005 for mounting the flap 6000 onto the thin metal strip 6001. A first gap 6007 and a second gap 6008 may be provided between flap 6000 and the stem 6005 for mounting flap 6000 to the metal strip 6001 by inserting a top portion 6009 and a bottom portion 6010 of the stem 6005 through the round hinge top 6003 and the round hinge bottom 6004. It may be preferable to form one of the first gap 6007 and the second gap 6008 to be larger than the other of the first gap 6007 and the second gap 6008 to allow for easier mounting of the stem 6005 by first sliding the portion of the stem 6005 corresponding with the larger gap into one of the round hinges 6003 or 6004 and then sliding the portion of the stem corresponding with the smaller gap into the other of the round hinges 6003 or 6004, respectively. FIG. 64A illustrates the insertion of the stem 6005 of the flap 6000, wherein the gap 6007 is larger so the top portion 6009 of the stem 6005 may be inserted up through the top round hinge 6003 as much as possible so that the bottom part 6010 of the stem 6005 is permitted to mount by insertion through the bottom round hinge 6004. As shown in FIG. 64A, mounting the flap 6000 in this manner allows gravity to maintain the bottom portion 6010 of the stem 6005 mounted through the bottom round hinge 6004 and the top portion 6009 of the stem 6005 mounted through the top round hinge 6003. To prevent the bottom part 6010 of the stem 6005 from dislodging from the bottom round hinge 6004, the bottom part 6010 may be formed with a part (not shown) that has a larger diameter than the through-hole of the hinge 6004. By mounting the end 6010 through the hinge 6004 in this manner may create a snap fit to prevent the flap 6000 from dislodging in strong or variable winds. If the flap 6000 is formed from semi-rigid (or flexible) material, the gaps 6007 and 6008 may be made equal. When using a semi-rigid or flexible material, the top portion 6009 and bottom portion 6010 of the stem 6005, for example, may be manufactured to be slightly longer with a rounded head. During mounting, one end portion of the stem 6005 may pass through and be mounted in one of the hinges 6003 or 6004. The stem 6005 may then be bent to mount the other end portion of the stem 6005 in the other of the hinges 6003 or 6004, respectively. To aid in the process of mounting the flap 6000 to the metal strip 6001, the top portion 6009 may be formed with a conical or round shape so that additional clearance may be gained in bending the stem 6005 for mounting the lower portion 6010 into the bottom hinge 6004. Once mounted, the wind forces do not act on the flap 6000 in a manner that would create bending of the stem 6005 severe enough to dislodge the stem 6005 from the hinges 6003 or 6004.

A design using the flap 6000 may be easier and less costly to manufacture, since the flap 6000 is generally symmetric and easy to manufacture by injection molding. The hinges, as discussed above, may also be configured to be shapes other than round. For example, as shown in FIG. 64B, a square top hinge 6012 and a square bottom hinge 6013 may be mounted for use with a rectangular flap stem (not shown) to mount a flap to the thin metal strip 6001. The rectangular shape of the stem may be used to prevent stem rotation, such as for use with the gear flap 1760 shown in FIG. 42 or the leaf flap shown in FIG. 27 where the stem should not rotate at all. An advantage of this type of flap arrangement is the suitability to a cold climate where ice accumulation between the flap 6000 and strip 6001 is minimized.

What is claimed is:

1. A check valve turbine assembly, comprising:
a rotation platform having an axis of rotation;
a vertical member concentrically secured to the rotation platform about the axis of rotation; and
a rotatable sail assembly attached to the vertical member, wherein the sail assembly comprises a frame, a hinge beam, and a rotatable sub-sail assembly attached to the hinge beam, wherein
the sub-sail assembly comprises a stem beam, a sub-sail grid frame attached to the stem beam, and a plurality of flaps rotatably attached to the sub-sail grid frame, and wherein
the flaps are configured to move between a closed position and an open position relative to the sub frame.

2. The check valve turbine assembly according to claim 1, further comprising at least one of a sub-sail motor for rotating the stem beam of the sub-sail and a sail motor attached to the sail frame for rotating the hinge beam.

3. The check valve turbine assembly according to claim 1, wherein at least one flap of the plurality of flaps comprises a primary flap member and a secondary flap member.

4. The check valve turbine assembly according to claim 2, further comprising multiple sub-sail assemblies, wherein the sub-sail motor comprises a pneumatic cylinder having a front lid and a rear lid forming air tight seals, a rack shaft supported within the cylinder, and multiple pinions supported on the front lid and connected to the stem beams of at least two of the sub-sail assemblies, the pinions driven by rotation of the rack shaft for simultaneously moving the sub-sail assemblies simultaneously.

5. The check valve turbine assembly according to claim 4, wherein the front lid of the pneumatic cylinder is configured to permit at least two tips of the rack shaft to rotate into the cylinder while maintaining the air-tight seal of the front lid.

6. The check valve turbine assembly according to claim 1, wherein two flaps of the plurality of flaps further comprise meshed gears and a support joint, and wherein the flaps act in tandem and are configured to open by each flap rotating away from the other flap and close by rotating toward the other flap.

7. The check valve turbine assembly according to claim 6, wherein the support joint comprises a snap ring for attachment to the sub-sail grid frame.

8. The check valve turbine assembly according to claim 1, wherein the at least one flap comprises a scoop portion having a curved back surface.

9. The check valve turbine assembly according to claim 1, further comprising a cage circumscribing the vertical member, wherein the cage comprises a vertical support member attached to a support ring supporting a tip of the stem beam of the sub-sail.

10. The check valve turbine assembly according to claim 1, wherein a portion of the stem beam is curved.

11. The check valve turbine assembly according to claim 1, further comprising a fixed sail attached to the hinge beam and adjacent to the vertical member.

12. A marine check valve turbine platform assembly, comprising:
a free-floating platform structure configured with an upper surface at or near a water surface;
a vertical member secured to the platform structure about an axis of rotation and configured to extend away from the upper surface of the platform structure;
a rotatable sail assembly attached to the vertical member; and
a power producing component connected to the vertical member and configured to be installed inside the platform structure below the water surface, wherein
the sail assembly comprises a frame, a hinge beam, and a rotatable sub-sail assembly attached to the hinge beam, wherein
the sub-sail assembly comprises a stem beam, a sub-sail grid frame attached to the stem beam, and a plurality of flaps rotatably attached to the sub-sail grid frame, and wherein
the flaps are configured to move between a closed position and an open position relative to the sub frame.

13. The marine check valve turbine platform assembly according to claim 12, further comprising a cage, wherein the cage comprises multiple vertical support members attached to the platform structure and support rings attached to the vertical support members for supporting a tip of the stem beam of the sub-sail assembly.

14. The marine check valve turbine platform assembly according to claim 12, wherein a lower level of sub-sail assemblies are configured to be close to the water surface.

15. The marine check valve turbine platform assembly according to claim 12, further comprising a Global Positioning System (GPS) that monitors a location of the free-floating platform structure.

16. The marine check valve turbine platform assembly according to claim 12, further comprising a propeller attached to the platform below the water surface.

17. A marine turbine system, comprising:
a floating platform;
a generator;
a gearbox connected to the generator; and
a check valve turbine assembly that drives the gearbox, the check valve turbine assembly comprising:
a vertical member rotatable relative an axis of rotation and connected to the gearbox; and
a rotatable sail assembly attached to the vertical member, wherein the sail assembly comprises a frame, a hinge beam, and a rotatable sub-sail assembly attached to the hinge beam, wherein
the sub-sail assembly comprises a stem beam, a sub-sail grid frame attached to the stem beam, and a plurality of flaps rotatably attached to the sub-sail grid frame, wherein
the flaps are configured to move between a closed position and an open position relative to the sub frame, and wherein
the floating platform supports the generator.

18. The marine turbine system according to claim 17, further comprising a fixed sail attached to the hinge beam and adjacent to the vertical member.

19. A check valve turbine assembly, comprising:
an assembly base;
a vertical member rotatably positioned within the assembly base;
a rotatable sail assembly attached to the vertical member, wherein the sail assembly comprises a frame, a hinge beam, and a rotatable sub-sail assembly attached to the hinge beam, wherein
the sub-sail assembly comprises a stem beam, a sub-sail grid frame attached to the stem beam, and a plurality of flaps rotatably attached to the sub-sail grid frame, and wherein
the flaps are configured to move between a closed position and an open position relative to the sub frame; and
a cage comprising multiple vertical support members attached to the assembly base and support rings attached to the vertical support members for supporting a tip of the stem beam of the sub-sail assembly.

20. The check valve turbine assembly according to claim 19, further comprising support arms that extend from the assembly base and support the vertical support members of the cage.

21. The check valve turbine assembly according to claim 20, further comprising fixed sails having fixed sail sub-sails that are attached to the support arms and extend vertically exterior to the cage.

22. A ring gear to roller gear power transmission mechanism for supporting a sail assembly of a check valve turbine, comprising:
a ring gear having gear teeth defined on a lower annular surface;
a roller gear mechanism comprising a roller gear and a shaft, wherein the roller gear is mounted on the shaft and engages with the gear teeth;
at least one support arm attached to the ring gear and which supports the sail assembly;
a vertical center beam supporting the ring gear; and
a generator, wherein the roller gear mechanism is attached to the vertical center beam member so that rotation of the sail assembly rotates the ring gear about the vertical center beam, the rotating ring gear rotates the roller gear, and the roller gear rotates the shaft which drives the generator to produce power.

23. A ring gear to sun gear power transmission mechanism for supporting a sail assembly of a check valve turbine, comprising:
an annular ring gear having gear teeth defined on an inner circumferential surface;
a planetary gear mechanism comprising at least one planetary gear and a sun gear, wherein the sun gear is mounted on a central shaft and engages the at least one planetary gear;
at least one support arm attached to the ring gear and configured to support the sail assembly;
a vertical center beam;
rollers attached to the center beam and rotatably supporting the ring gear; and
a generator, wherein the ring gear is rotated when the sail assembly rotates and is engaged with the planetary gear mechanism to drive a rotation of the sun gear, the rotation of the sun gear rotates the central shaft, which is configured to drive the generator.

24. A support bearing system for supporting a sail assembly of a check valve turbine assembly, comprising:
a vertical mast;
an annular groove ring attached to the mast and comprising a roller groove;
a segmented ring gear comprising at least one roller gap and configured to fit circumferentially outside of the annular groove ring;
a support arm attached to the ring gear and configured to provide support for the sail assembly; and
at least one roller, wherein the roller is mounted to the ring gear, passes through the roller gap, and engages the roller groove of the groove ring.

25. A hydraulic accumulator system for use with a marine check valve turbine, comprising:
a tank configured to be filled with pressurized fluid;
at least one compressible air chamber inside the tank;
a hydraulic pump configured to be driven by the marine check valve turbine;
a hydraulic turbine configured to be driven by the pressurized fluid in the tank; and
a propeller attached to the hydraulic turbine, wherein
activation of the marine check valve turbine drives the hydraulic pump forcing additional fluid into the tank, the air chamber inside the tank compresses as a fluid pressure increases, and the pressurized fluid is forced from the tank to drive the hydraulic turbine to turn the propeller, and wherein
the air chamber decompresses when the check valve turbine deactivates, maintaining the fluid pressure in the tank to drive the hydraulic turbine to turn the propeller.
